(19) United States
(12) Patent Application Publication
(10) Pub. No.: US 2020/0226465 A1
(43) Pub. Date: Jul. 16, 2020

(54) NEURAL NETWORK PROCESSING OF RETURN PATH DATA TO ESTIMATE HOUSEHOLD MEMBER AND VISITOR DEMOGRAPHICS

(71) Applicant: The Nielsen Company (US), LLC, New York, NY (US)

(72) Inventors: Thomas Harrington, New York, NY (US); Denis Voytenko, Oldsmar, FL (US); Parminder Singh Bhogal, Tampa, FL (US); Paul Chimenti, Tampa, FL (US); Sikavas Nalampang, Oldsmar, FL (US); Balachander Shankar, Tampa, FL (US); David J. Kurzynski, South Elgin, IL (US)

(21) Appl. No.: 16/706,398

(22) Filed: Dec. 6, 2019

Related U.S. Application Data
(63) Continuation-in-part of application No. 16/230,620, filed on Dec. 21, 2018.
(60) Provisional application No. 62/743,925, filed on Oct. 10, 2018.
(60) Provisional application No. 62/841,641, filed on May 1, 2019.

(51) Int. Cl. G06N 3/08; H04N 21/258; G06N 3/04

(52) U.S. Cl. CPC G06N 3/08; G06N 3/04; H04N 21/25808

(57) ABSTRACT

Example demographic estimation systems disclosed herein include a feature generator to generate features from return path data reported from set-top boxes associated with return path data households; a neural network to process the features generated from the return path data to predict demographic classification probabilities for the return path data households, the neural network to be trained based on panel data reported from meters that monitor media devices associated with panelist households; a demographic assignment engine to assign one or more demographic categories to respective ones of the return path data households based on the predicted demographic classification probabilities; and a visitor assignment engine to assign virtual visitors to at least a subset of the respective ones of the return path data households based on the one or more demographic categories assigned to the respective ones of the return path data households.

### RELATED APPLICATION(S)

This patent arises from a continuation-in-part of U.S. patent application Ser. No. 16/230,620, titled “NEURAL NETWORK PROCESSING OF RETURN PATH DATA TO ESTIMATE HOUSEHOLD DEMOGRAPHICS” and filed on Dec. 21, 2018, which claims the benefit of and priority to U.S. Provisional Application Ser. No. 62/743,925, titled “NEURAL NETWORK PROCESSING OF SET-TOP BOX RETURN PATH DATA TO ESTIMATE HOUSEHOLD DEMOGRAPHICS” and filed on Oct. 10, 2018. This patent also claims the benefit and priority to U.S. Provisional Application Ser. No. 62/841,641, titled “NEURAL NETWORK PROCESSING OF RETURN PATH DATA TO ESTIMATE HOUSEHOLD MEMBER AND VISITOR DEMOGRAPHICS” and filed on May 1, 2019. Priority to U.S. patent application Ser. No. 16/230,620, U.S. Provisional Application Ser. No. 62/743,925 and U.S. Provisional Application Ser. No. 62/841,641 is claimed. U.S. patent application Ser. No. 16/230,620, U.S. Provisional Application Ser. No. 62/743,925 and U.S. Provisional Application Ser. No. 62/841,641 are hereby incorporated herein by reference in their respective entireties.

### FIELD OF THE DISCLOSURE

This disclosure relates generally to neural networks and, more particularly, to neural network processing of return path data to estimate household member and visitor demographics.

### BACKGROUND

Audience measurement entities (AMEs), such as The Nielsen Company (US), LLC, may extrapolate ratings metrics and/or other audience measurement data for a total television viewing audience from a relatively small sample of panel homes. The panel homes may be well studied and are typically chosen to be representative of an audience universe as a whole. Furthermore, to help supplement panel data, an AME, such as The Nielsen Company (US), LLC, may reach agreements with pay-television provider companies to obtain the television tuning information derived from set top boxes and/or other devices/software, which is referred to herein, and in the industry, as return path data.

### BRIEF DESCRIPTION OF THE DRAWINGS

FIG. 1 is a block diagram of an example processing flow to estimate demographic classification probabilities from set-top box return path data using a neural network in accordance with teachings of this disclosure.

FIG. 2 is a block diagram of an example processing flow to use the demographic classification probabilities estimated by the example processing flow of FIG. 1 to assign demographics to households in accordance with teachings of this disclosure.

FIG. 3 is a block diagram of an example neural-network-based demographic estimation system structured to implement the processing flows of FIGS. 1 and 2 to estimate household demographics from set-top box return path data in accordance with teachings of this disclosure.

FIGS. 4A-B illustrate example features generated by the example feature generator included in the example neural-network-based demographic estimation system of FIG. 3.

FIG. 5 is a block diagram of an example implementation of the example demographic prediction neural network included in the example neural-network-based demographic estimation system of FIG. 3.

FIGS. 6A-C illustrate an example operation of the demographic prediction neural network of FIG. 3 to estimate demographic classification probabilities from set-top box return path data in accordance with teachings of this disclosure.

FIG. 7 illustrates example pseudocode for implementing the example household demographic assignment engine included in the example neural-network-based demographic estimation system of FIG. 3.

FIGS. 8A-E illustrate an example operation of the household demographic assignment engine of FIG. 3 to assign demographics to households in accordance with teachings of this disclosure.

FIGS. 9A-C illustrate example simulated annealing operations that may be performed by the household demographic assignment engine of FIG. 3.

FIG. 10 is a block diagram of a second example neural-network-based demographic estimation system structured to estimate household demographics for primary household members and long term visitors from set-top box return path data in accordance with teachings of this disclosure.

FIG. 11 is a block diagram of an example visitor assignment engine included in the example neural-network based demographic estimation system of FIG. 10 to assign virtual visitors to return path data households in accordance with teachings of this disclosure.

FIG. 12 is a flowchart representative of example computer readable instructions that may be executed to implement the neural-network-based demographic estimation system of FIG. 3.

FIG. 13 is a flowchart representative of example computer readable instructions that may be executed to implement the second neural-network-based demographic estimation system of FIG. 10.

FIGS. 14-15 are flowcharts representative of example computer readable instructions that may be executed to implement the example demographic targets adjuster included in the neural-network based demographic estimation system of FIG. 10.

FIGS. 16-18 are flowcharts representative of example computer readable instructions that may be executed to implement the visitor assignment engine of FIG. 10.

FIG. 19 is a flowchart representative of example computer readable instructions that may be executed to implement the visitor vector assigner of FIG. 11 under the constraint that one visitor is to be assigned to a given household.

FIG. 20 is a block diagram of an example processor platform structured to execute the example machine readable instructions of FIG. 12 to implement the example neural-network-based demographic estimation system of FIG. 3.

FIG. 21 is a block diagram of an example processor platform structured to execute the example machine readable instructions of FIGS. 13, 14, 15, 16, 17, 18, and/or 19 to implement the example neural-network-based demographic estimation system of FIG. 10.

The figures are not to scale. In general, the same reference numbers will be used throughout the drawing(s) and accompanying written description to refer to the same or like parts, elements, etc.

### DETAILED DESCRIPTION

Descriptors “first,” “second,” “third,” etc., are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

Example methods, apparatus, systems and articles of manufacture (e.g., physical storage media) to implement neural network processing of return path data to estimate household demographics are disclosed herein. Example of such demographic estimation systems disclosed herein include a feature generator to generate features from return path data reported from set-top boxes associated with return path data households. Example demographic estimation systems disclosed herein also include a neural network to process the features generated from the return path data to predict demographic classification probabilities for the return path data households. Example demographic estimation systems disclosed herein further include a demographic assignment engine to assign one or more demographic categories to respective ones of the return path data households based on the predicted demographic classification probabilities

These and other example methods, apparatus, systems and articles of manufacture (e.g., physical storage media) to implement neural network processing of return path data to estimate household demographics are disclosed in further detail below.

As noted above, AMEs extrapolate ratings metrics and/or other audience measurement data for a total television viewing audience from a relatively small sample of panelist households, also referred to herein as panel homes. The panel homes may be well studied and are typically chosen to be representative of an audience universe as a whole. However, accurately representing the geographic distribution and demographic diversity that exists in the total audience population with a small sample of panel homes remains a challenge. Incorporating additional streams of information about media exposure to the total audience population can fill in gaps or biases inherent to any statistical sample.

To help supplement panel data, an AME, such as The Nielsen Company (US), LLC, may reach agreements with pay-television provider companies to obtain the television tuning information derived from set top boxes, which is referred to herein, and in the industry, as return path data (RPD). Set-top box (STB) data includes all the data collected by the set-top box. STB data may include, for example, tuning events and/or commands received by the STB (e.g., power on, power off, change channel, change input source, start presenting media, pause the presentation of media, record a presentation of media, volume up/down, etc.). STB data may additionally or alternatively include commands sent to a content provider by the STB (e.g., switch input sources, record a media presentation, delete a recorded media presentation, the time/date a media presentation was started, the time a media presentation was completed, etc.), heartbeat signals, or the like. The set-top box data may additionally or alternatively include a household identification (e.g. a household ID) and/or a STB identification (e.g. a STB ID).

Return path data includes any data receivable at a media service provider (e.g., a such as a cable television service provider, a satellite television service provider, a streaming media service provider, a content provider, etc.) via a return path to the service provider from a media consumer site. As such, return path data includes at least a portion of the set-top box data. Return path data may additionally or alternatively include data from any other consumer device with network access capabilities (e.g., via a cellular network, the internet, other public or private networks, etc.). For example, return path data may include any or all of linear real time data from an STB, guide user data from a guide server, click stream data, key stream data (e.g., any click on the remote—volume, mute, etc.), interactive activity (such as Video On Demand) and any other data (e.g., data from middleware). RPD data can additionally or alternatively be from the network (e.g., via Switched Digital software) and/or any cloud-based data (such as a remote server DVR) from the cloud.

RPD can provide insight into the media exposure associated with a larger segment of the audience population. This is because RPD typically provides a rich stream of television viewing information for a much larger number of households than are included in an AME's panel homes. However, unlike the well-studied AME panel homes, the demographic details of pay-television subscribers are typically unknown. This lack of demographic details in the RPD can result in technical problems preventing, or at least limiting, the ability to effectively use RPD to supplement the AME's panel data because monitoring the behavioral profiles of various audience demographics requires knowledge of the demographic composition of the subscriber homes providing the RPD.

Neural network processing of set-top box RPD to estimate household demographics as disclosed herein provides a technical solution to the technical problem of combining RPD with panel data for audience measurement. As disclosed in further detail below, example neural-network-based demographic estimation systems implemented in accordance with teachings of this disclosure use panel data collected from monitored AME panel homes as a training set for training a neural network (e.g., a recurrent neural network) to be able to predict, from RPD tuning data describing historical television tuning behavior, probabilities of different household demographic characteristics being associated with respective ones of the RPD households reporting the RPD data. Disclosed example neural-network-based demographic estimation system predictions then use the predicted probabilities of different household demographic characteristics to assign demographic compositions to households. In this way, example neural-network-based demographic estimation systems assign demographic compositions to the subscriber homes providing the RPD, thereby allowing the RPD to be combined with or to otherwise enhance the panel data driving an AME's audience measurement systems. Such example neural-network-based demographic estimation systems are also referred to as implementing an example Household Demographic Assignment Model (HDAM) to assign demographic compositions to households.

In some disclosed examples, the HDAM implemented by the neural-network-based demographic estimation system predicts household level demographic assignments based on television viewing data, but predict the household level demographics for primary household members and not long term visitors. As used herein, a long-term visitor is a person who visits the home more than once and/or for an extended period of time, such as at least once every two weeks, or, stays in the home for at least one month in a calendar year. A long term visitor has a primary residence elsewhere, are not household members, and typically watches and/or listens to television in the home during at least a portion of their visits or extended stay. However, other criteria can be used to classify individuals as long-term visitors, taking into account factors such as improvement to household compliance. Some examples disclosed herein modify the HDAM model to predict demographics long term visitors while being consistent with the long-term visitor distributions obtained from panel data obtained by the AME by monitoring its panelists, such as Nielsen People Monitoring (NPM) panel data generated by The Nielsen Company (US), LLC.

In some examples disclosed herein, the modification to the HDAM model to predict demographics of long term visitors uses long term visitor data available from the AME's panel data. Using this panel data, the percentages of total people in each age-gender bucket that are long term visitors can be determined. Taking the estimates for the total number of people in each age-gender bucket, these estimated totals can be modified to include visitors based on the panel visitor percentages. By modifying the population targets applied to the HDAM model, the HDAM model can be modified to predict household compositions that contain both long term visitors and primary household members.

Example disclosed herein distinguish the long term visitors from the primary household members. In some examples, the expected aggregate level long term visitor population and age-gender distributions are known from the AME's panel data. The output of the HDAM model can be thought of as a vector containing the total number of long term visitors and primary household members in each of the various demographic categories (e.g., age-gender buckets). Knowing the percentage of long term visitors in each demographic category (e.g., each age-gender group), a population of long term visitors can be assigned to the homes to satisfy the expected distribution across demographic categories. In examples disclosed herein, a set of visitor vectors are created that satisfy the panel informed consistency requirements. After creating the visitor vectors, homes in which these visitor vectors can be placed are determined. For example, the set of possible (candidate) homes (from the HDAM predictions) that each visitor vector could be assigned are determined. Using the probabilities that respective ones of the individual homes have a long term visitor, the visitor vectors are placed in the homes, prioritizing the homes that are more likely to have long term visitors. Examples disclosed herein produce long term visitor assignments to the predicted homes that automatically satisfy the panel informed consistency requirements without disrupting/impacting the HDAM predictions for primary household members. As a result, primary household member assignments and long term visitor assignments can be achieved by examples disclosed herein.

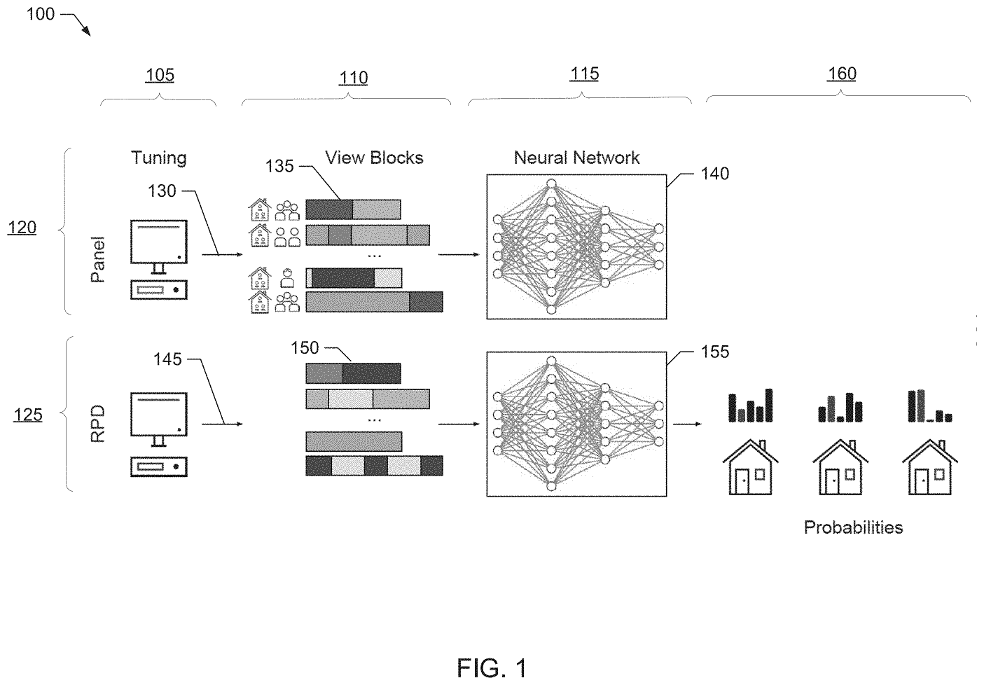

Turning to the figures, a block diagram of an example processing flow 100 to estimate demographic classification probabilities from set-top box RPD using a neural network in accordance with teachings of this disclosure is illustrated in FIG. 1. The example processing flow 100 includes an example data collection phase 105, an example feature generation phase 110 and an example neural network demographic probability prediction phase 115. The example processing flow 100 is further divided into an example neural network training branch 120 and an example neural network application branch 125.

In the data collection phase 105 of the neural network training branch 120, example panelist tuning data 130 is collected from meters monitoring media exposure in panel homes recruited by an AME. Panelist tuning data 130 can include any data collectable by the meters, such as, but not limited to, data identifying media presented by media devices in the panel homes, demographic data identifying characteristics of the panelists in the panel homes, etc. In the feature generation phase 110 of the neural network training branch 120, example features 135 are generated from the collected panelist tuning data 130 and arranged to form feature vectors, as described in further detail below. In the neural network demographic probability prediction phase 115 of the neural network training branch 120, a neural network 140 is trained to predict, from the features 135 generated from the collected panelist tuning data 130, probabilities of different household demographic characteristics being associated with the different panel homes, as described in further detail below.

In the data collection phase 105 of the neural network application branch 125, example RPD tuning data 145 is collected from set-top boxes of one or more pay television providers (e.g., cable television service providers, satellite television service providers, streaming media service providers, content providers, etc.). A set-top box may also refer to any decoder, receiver, integrated receiver-decoder (IRD), media device, etc., from which the RPD tuning data 145 may be collected. In the feature generation phase 110 of the neural network application branch 125, example features 150 are generated from the collected RPD tuning data 145 and arranged to form feature vectors, as described in further detail below. In the neural network demographic probability prediction phase 115 of the neural network application branch 125, the trained neural network 155 is applied to the features 150 generated from the collected RPD tuning data 145 to predict example estimated probabilities 160 of different household demographic characteristics being associated with the different RPD subscriber households that reported the RPD tuning data 145, as described in further detail below

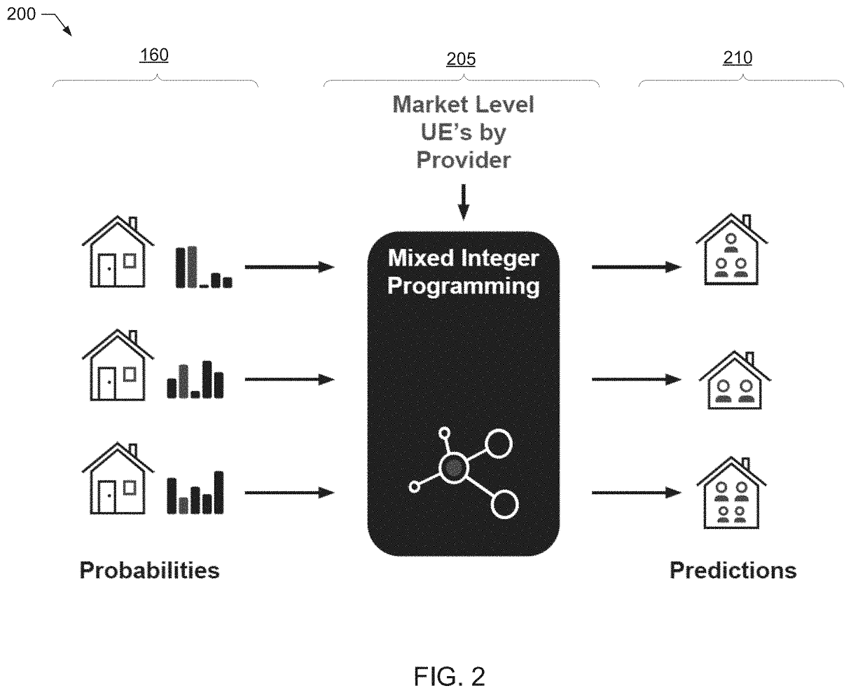

A block diagram of an example processing flow 200 to use the estimated demographic classification probabilities 160 predicted by the example processing flow 100 of FIG. 1 to assign demographics to households in accordance with teachings of this disclosure is illustrated in FIG. 2. As disclosed in further detail below, the processing flow 200 utilizes an example mixed integer programming solution 205, which solves a constrained optimization problem based on the estimated demographic classification probabilities 160 predicted by the example processing flow 100, to assign example, estimated demographic compositions 210 to the subscriber homes that provided the RPD tuning data 145.

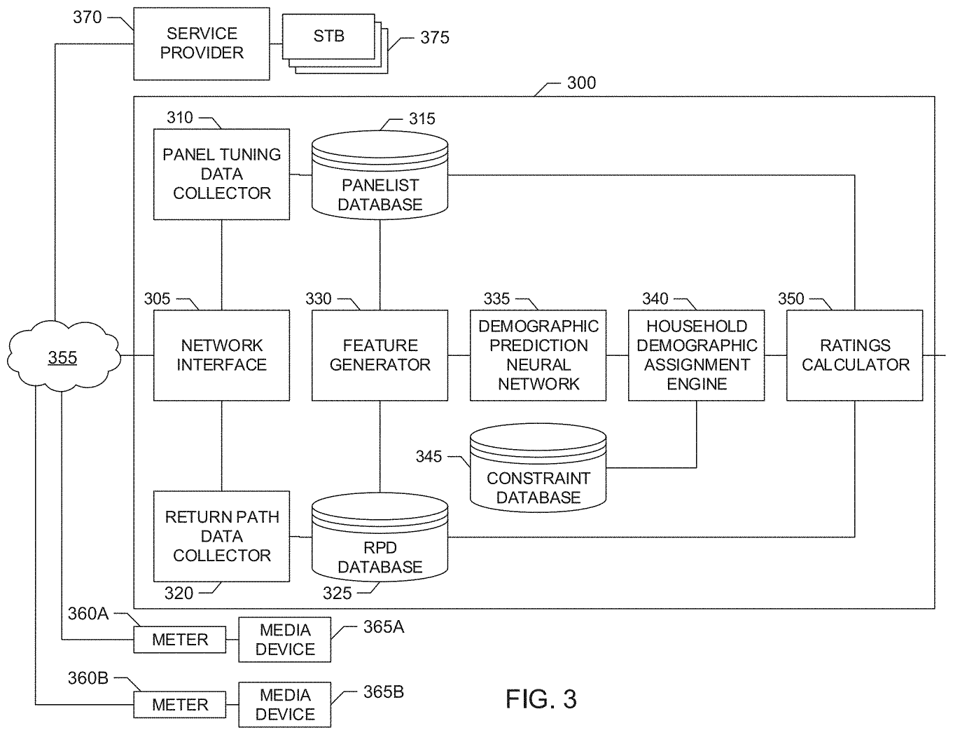

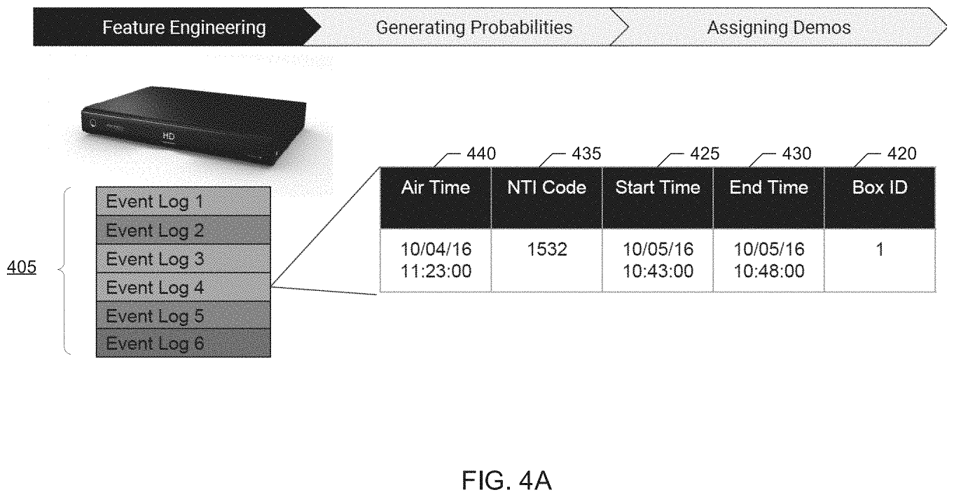

A block diagram of an example neural-network-based demographic estimation system 300 structured to implement the processing flows 100 and 200 of FIGS. 1 and 2, respectively, to estimate household demographics for primary household members from set-top box RPD in accordance with teachings of this disclosure is illustrated in FIG. 3. The example neural-network-based demographic estimation system 300 includes an example network interface 305, an example panel tuning data collector 310, an example panelist database 315, an example RPD data collector 320, an example RPD database 325, an example feature generator 330, an example demographic prediction neural network 335, an example household demographic assignment engine 340, an example constraint database 345 and an example ratings calculator 350.

In the illustrated example, the panel tuning data collector 310 collects, via the network interface 305 in communication with one or more example networks 355, the panelist tuning data 130 from example meters 360A-B monitoring media exposure associated with example media devices 365A-B (e.g., televisions, radios, computers, tablet devices, smart phones, etc.) in panel homes recruited by an AME. The panel tuning data collector 310 stores the collected panelist tuning data 130 in the panelist database 315. In the illustrated example, the RPD data collector 320 collects, via the network interface 305 in communication with the one or more networks 355, the RPD tuning data 145 from one or more example service providers 370 that collect the RPD tuning data 145 from example individual STBs 375 in the subscriber households. Additionally or alternatively, in some examples, the RPD data collector 320 collects the RPD tuning data 145 from tone or more of the individual STBs 375 in the subscriber households directly via the network interface 305 in communication with the one or more networks 355. The RPD data collector 320 stores the collected RPD tuning data 145 in the RPD database 325.

The feature generator 330 of the illustrated example generates the features and feature vectors used by the example demographic prediction neural network 335. In some examples, RPD tuning data consists of sequential logs of when respective set top boxes were tuned to different stations. Individuals (e.g., audience members) transfer between multiple networks over the course of a contiguous television viewing session, and this pattern of activity may provide additional information about the household beyond the tuning record in isolation. To capture this behavior, the feature generator 330 compiles the STB records of television tuning into “view blocks” that aggregate the viewing behavior of one or more unknown viewers into a fixed number of features summarizing each contiguous viewing session. In some examples, view block durations are capped at 1 hour, or some other duration, to account for situations in which multiple viewers may take control of a television without necessarily turning the television off between sessions. In the illustrated example, each view block contains F features recording information about the start time of the view block, channel click rate, duration of the viewing sessions and a listing of the television stations visited during the session.

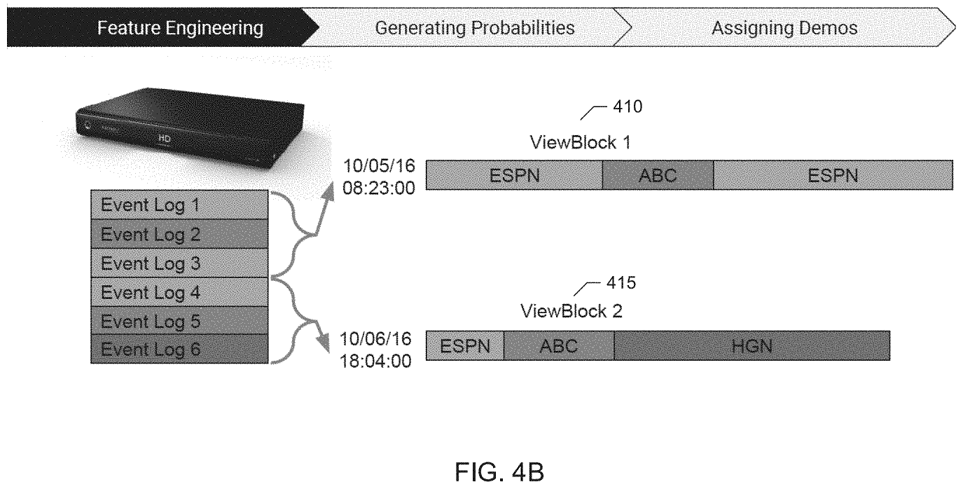

FIGS. 4A-B illustrate an example operation of the feature generator 330 to combine example RPD tuning data records 405 from the RPD tuning data 145 into corresponding example view blocks 410 and 415. In the illustrated example of FIG. 4A, respective ones of the data records 405 record tuning events reported by the STBs 375. A given data record 405 specifies an STB identifier STB ID) 420 identifying the STB corresponding to the event log, start and end times 425 and 430, respectively, corresponding to the tuning event represented by the event log, a source identifier (SID) 435 identifying the media source (e.g., channel number, station identifier, etc.) associated with the tuning event, and a broadcast time 440 identifying when the media associated with the tuning event originally aired (e.g., to distinguish between live and time-shifted tuning events). In the illustrated example of FIG. 4B, the view block 410 aggregates the tuning events recorded in the data records 405 for a given household and occurring in the hour interval beginning at 8:23 AM on Nov. 5, 2016. In the illustrated example of FIG. 4B, the view block 415 aggregates the tuning events recorded in the data records 405 for a given household and occurring in the hour interval beginning at 6:04 PM on Nov. 6, 2016.

The feature generator 330 of the illustrated example groups view blocks by household and a group of N view blocks is assembled into a two-dimensional (N×F) matrix containing a record of the view blocks generated by a household over a given observation period. In some examples, the feature generator 330 aggregates relevant household level features, including the number of television tuners, and the amount of television watched, with the view block data, into an H dimensional (1×H) additional feature vector for each household.

In some examples, each view block is a (1×173) feature vector describing a corresponding television viewing session. As such, the corresponding (N×F) matrix has an F dimension of 173 for this examples. Table 1 illustrates the contents of an example view block represented as a (1×173) feature vector.

TABLE 1

| Index | Short Description | Valid Range |
|---|---|---|
| 0 | Day of week | 0-6 |
| 1 | Day of Year | 0-364 |
| 2 | Quarter Hour of Day | 0-95 |
| 3 | Channel Change Rate | 0-Inf |
| 4-173 | Minutes Each Network Was Viewed | 0-60 |

The first three features in Table 1 are self-explanatory. The “Channel Change Rate” feature of Table 1 is the ratio of the number of times the channel changed during the view block to the duration of the view block in minutes. The “Minutes Viewing Each Network” feature is the total number of minutes each television station was watched. In the example of Table 1, view blocks are capped at 60 minutes duration and, thus, the summation of these features over all networks is to be <=60.0 minutes. In some such examples, a viewing session may thereby be associated with one or more view blocks. In the example of Table 1, each station is randomly assigned an index value between 4 and 173.

In some examples, view blocks (from panel households) containing less than 5 minutes of television viewing behavior are not used to train the demographic prediction neural network 335. The view blocks for each household (e.g., panel households for neural network training and RPD households for neural network application) are then stacked into a two-dimensional matrix with, for example, 400 rows (e.g., N=400). In some examples, households that generated fewer than 400 unique view blocks are zero padded by the feature generator 330 until they have 400 rows, while those with greater than 400 are truncated by the feature generator 330 to the first 400 rows. The two-dimensional arrays from each household are then stacked by the feature generator 330 to forming a three-dimensional matrix that can be fed into the demographic prediction neural network 335.

In some examples, the feature generator 330 augments viewing data with three household level features, H, that are merged into the demographic prediction neural network 335 following a recurrent layer, as described below. Table 2 illustrates an example set of the three household level features, H, corresponding to (i) a total amount of tuning reported for the given household across the different durations of time covered by the view blocks (e.g., a 24 hour period) (corresponding to Index 0 in the table), (ii) a number of view blocks reported for the given household across the different durations of time (corresponding to Index 1 in the table), and (iii) a total number of tuners included in the first one of the return path data households (corresponding to Index 2 in the table).

TABLE 2

| Index | Short Description | Valid Range |
|---|---|---|
| 0 | Total TV Consumption (Minutes) | 1-Inf |
| 1 | Number of View Blocks Recorded | 1-Inf |
| 2 | Number of Television Tuners in House | 1-Inf |

In the illustrated example, the demographic prediction neural network 335 is structured to predict 20 variables (e.g., a 1×20 vector) representing probabilities of different household level demographics being present in a household (although other numbers of variables representing other demographics could additionally or alternatively be predicted in other example implementations of the demographic prediction neural network 335). In the illustrated example, fourteen household demographic target variables predicted by the demographic prediction neural network 335 indicate the respective probabilities (e.g., likelihoods) of 14 different age gender combinations being present in the household, examples of which are represented in Table 3.

TABLE 3

| Index | Age/Gender | |
|---|---|---|
| 0 | 0-12 | |
| 1 | 13-17 | |
| 2 | 18-24 | Male |
| 3 | 25-34 | Male |
| 4 | 35-44 | Male |
| 5 | 45-54 | Male |
| 6 | 55-64 | Male |
| 7 | 65+ | Male |
| 8 | 18-24 | Female |
| 9 | 25-34 | Female |
| 10 | 35-44 | Female |
| 11 | 45-54 | Female |
| 12 | 55-64 | Female |
| 13 | 65+ | Female |

In addition to the presence variables of Table 3, in some examples, the demographic prediction neural network 335 predicts six additional target variables describing the demographic profile of the head of household (HOH), examples of which are represented in Table 4.

TABLE 4

| Index | HOH Characteristics |
|---|---|
| 14 | HOH Age |
| 15 | HOH Gender |
| 16 | Hispanic Origin |
| 17 | European American |
| 18 | African American |
| 19 | Asian American |

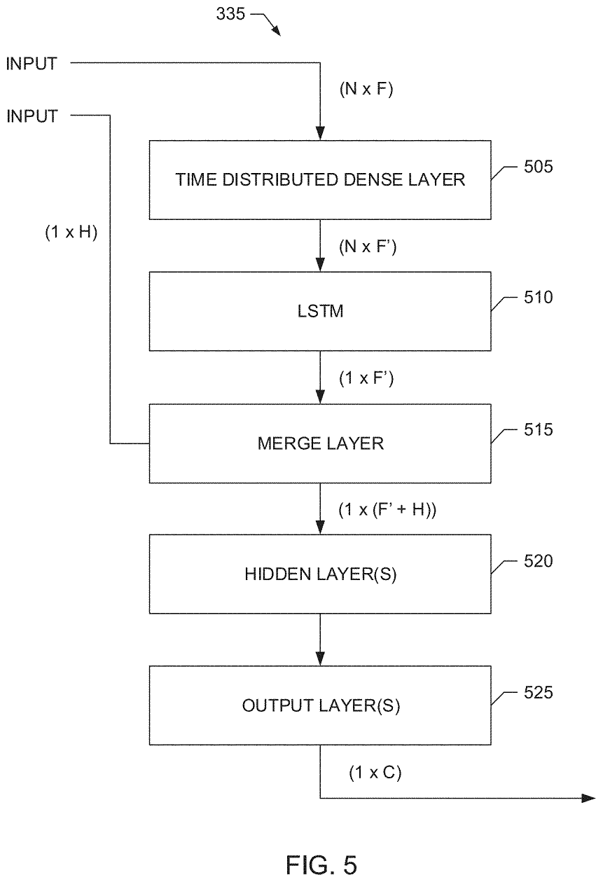

An example implementation of the demographic prediction neural network 335 of FIG. 3 is illustrated in FIG. 5. In some examples, the two-dimensional (N×F) feature vectors (e.g., 400×173 feature vectors) generated for respective ones of the households being processed (e.g., panel and/or RPD households) are typically sparse (for example, many broadcast networks that are represented in the feature vectors are never visited during a given view block). To condense this input into a smaller subset of features, the demographic prediction neural network 335 includes an example Time Distributed Dense Layer (TDDL) 505 that learns a single set of weights mapping each view block to a condensed representation of the input (N×F′ where F′<<F). This compressed data is then fed into an example Long Short Term Memory (LSTM) recurrent neural network layer 510. The LSTM 510 examines each row of the view block matrix in sequence and uses that information to selectively update a singular internal state vector that encodes information from each viewing session/view block. The output of the LSTM 510 is a one-dimensional (1×F′) feature vector that summarizes the history of evidence observed for each household. The example demographic prediction neural network 335 of FIG. 5 includes an example merge layer 515 to merge (concatenate) additional (1×H) household level features with the one-dimensional representation of the viewing data output from the LSTM 510. The additional (1×H) household level features include details about the total number of devices in the household, the total minutes watched over the observation window and total number of view blocks that were recorded for the particular household over the observation window, as described above.

In the example demographic prediction neural network 335 of FIG. 5, the augmented feature vector output from the merge layer 515 is passed to one or more additional example hidden layer(s) 520 before being output from an example output layer 525 as a (1×C) probability vector representing the respective predicted probabilities of the C possible demographic categories being present in the household. The C demographic classes modeled by the demographic prediction neural network 335 need not be mutually exclusive (e.g., households may contain multiple people of different age/genders) so the output vector encodes the relative probability each modeled household level demographic is present in the unknown household.

Table 5 lists example dimensions of the data at each stage of the example demographic prediction neural network 335 of FIG. 5. In Table 5, N is the total number of view blocks per household, F the number of features in each view block, F′ the number of dense features generated by the TDDL 505 and H the number of additional household specific features.

TABLE 5

| Dimension | Number of Nodes |
|---|---|
| H | 3 |
| N | 400 |
| F | 173 |
| F′ | 30 |
| C | 20 |

In some examples, to prevent the demographic prediction neural network 335 from over-fitting, and enable it to better generalize, the feature generator 330 shuffles the order of blocks fed into demographic prediction neural network 335 during each training epoch.

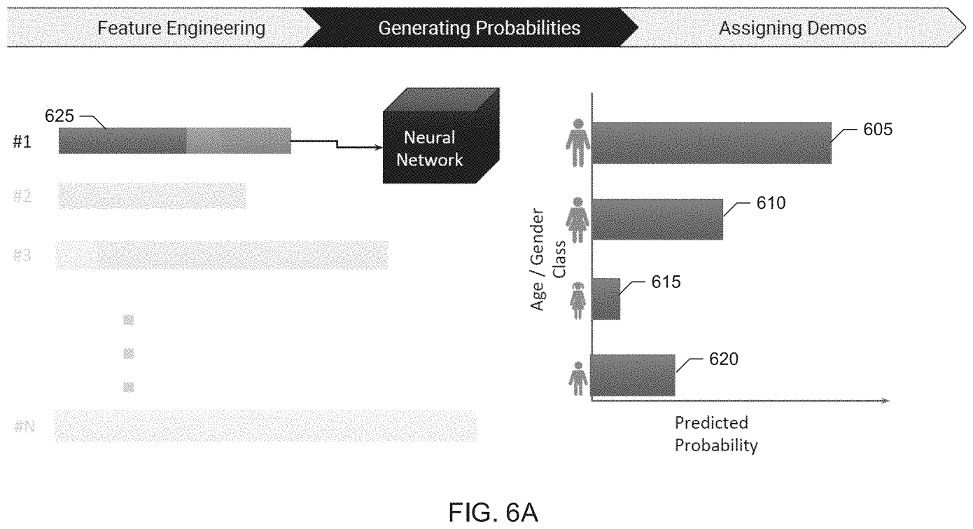

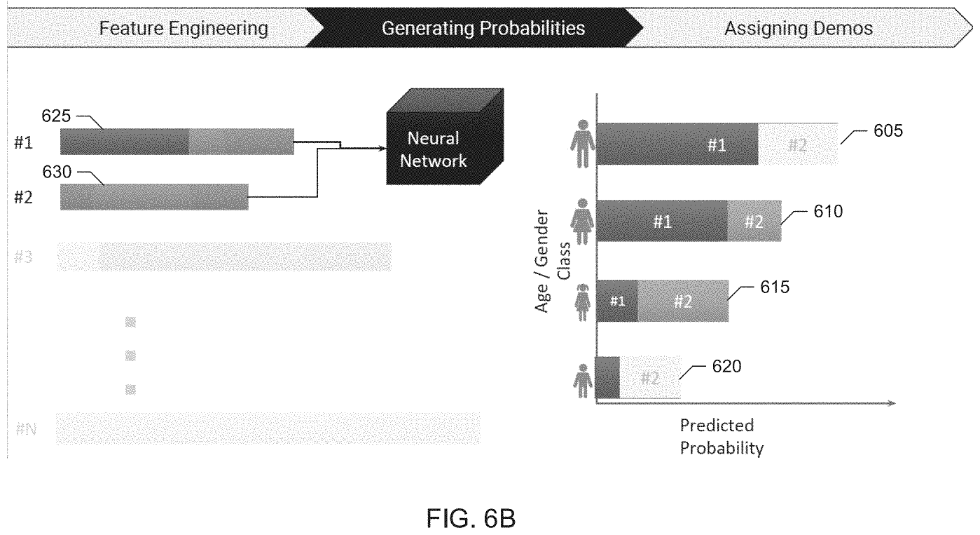

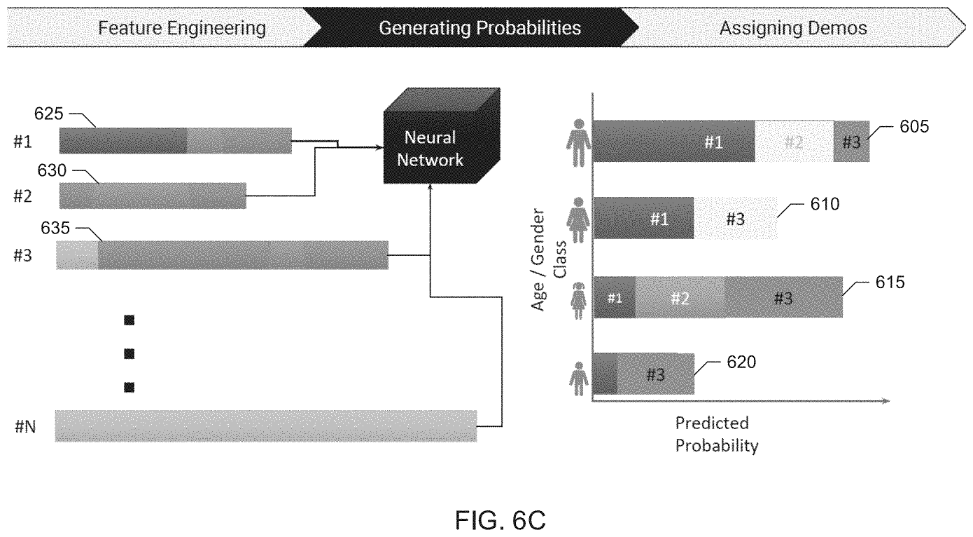

FIGS. 6A-C illustrate an example operation of the demographic prediction neural network 335 to predict demographic target variables 605, 610, 615, and 620 as feature vectors 625, 630, and 635 generated from RPD tuning data 145 are applied to the demographic prediction neural network 335 after the demographic prediction neural network 335 has been trained with feature vectors generated from the panelist data 130. In the illustrated example, the demographic prediction neural network 335 is trained by (i) creating view blocks from the panelist tuning data 130 reported for the panelist household, (ii) generating the features for respective ones of the panelist households from the view blocks created for the respective panelist households, as described above, and (iii) applying the features for the respective ones of the panelist households to the neural network 335 according to any training procedure that adjusts the internal parameters of the neural network to reduce an error between the predicted demographic classification probabilities 160 output by the neural network 335 and the actual demographics known for the panelist households. As illustrated in the example of FIGS. 6A-C, as more view blocks are applied to train the neural network 335, the output of the network 335 will converge to predict demographic classification probabilities 160 in line with the actual demographics known for the panelist households.

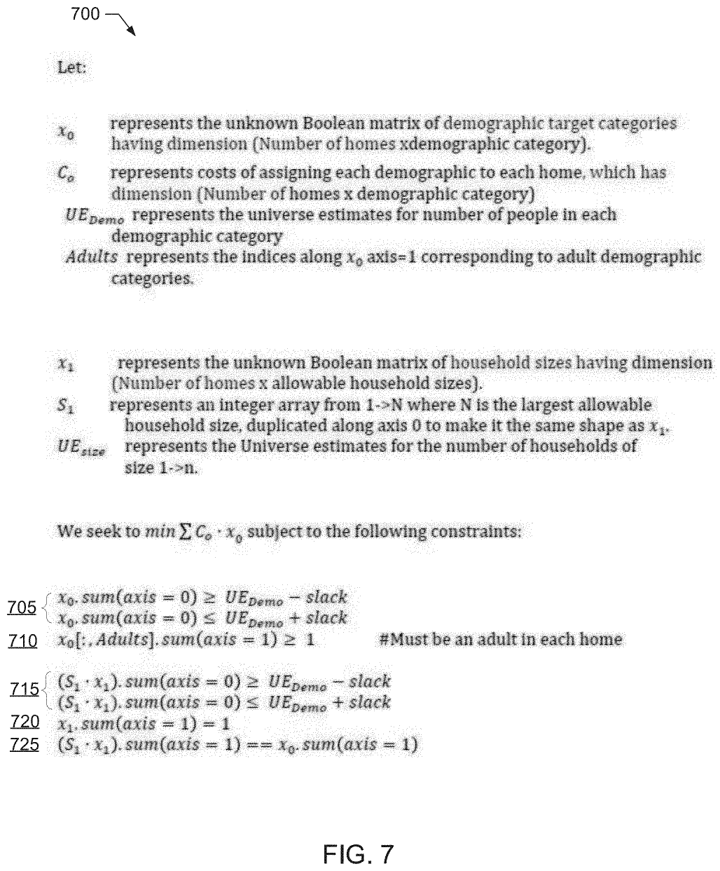

Returning to FIG. 3, the example household demographic assignment engine 340 of the example neural-network-based demographic estimation system 300 uses the estimated demographic classification probabilities (also referred to as the predicted demographic target variables above) output from the demographic prediction neural network 335 to assign demographics to RPD households in accordance with teachings of this disclosure. FIG. 7 illustrates example pseudocode 700 for implementing household demographic assignment engine 340. The example pseudocode 700 also corresponds to an example of the mixed integer programming solution 205 of FIG. 2. In the illustrated example of FIG. 7, the pseudocode 700 to implement the household demographic assignment engine 340 assigns demographics to households by solving an objective function to determine a matrix x0, which is a Boolean matrix that represents the demographic categories assigned to different RPD households, given a cost matrix CO, which represents the cost of assigning different demographic categories to the RPD households, subject to a set of constraints having values stored in the example constraint database 345. In the example of FIG. 7, the matrix x0 is a matrix having a number of rows equal to the number of RPD households, and a number of columns equal to the number of different possible demographic categories that can be assigned to a household. Furthermore, in the illustrated example, for a given row of x0 representing a given RPD household, the elements of the row contain binary (Boolean) variables representing the different possible demographic categories, with the given binary variable representing a given possible demographic category being assigned a value of 1 by the pseudocode 700 if that demographic category is assigned to that RPD household, or being assigned a value of 0 by the pseudocode 700 if that demographic category is not assigned to that RPD household. In the example of FIG. 7, the matrix CO is also a matrix having a number of rows equal to the number of RPD households, and a number of columns equal to the number of different possible demographic categories that can be assigned to a household. Furthermore, in the illustrated example, for a given row of CO representing a given RPD household, the elements of the row contain cost variables representing the respective costs for assigning the different possible demographic categories to the given RPD household. In some examples, the costs variables in CO are determined by the household demographic assignment engine 340 based on the estimated demographic classification probabilities (also referred to as the predicted demographic target variables above) output from the demographic prediction neural network 335. For example, the cost variable for assigning a given possible demographic category to the given RPD household can be determined by the household demographic assignment engine 340 as the inverse (or some other function) of the demographic classification probability for that demographic category and RPD household as determined by the demographic prediction neural network 335.

As illustrated in the example of FIG. 7, the pseudocode 700 employs any mixed integer programming or similar technique to determine the demographic assignment matrix x0 by solving the objective function:

$${\sum }_{i , j} {C}_{0} ( i , j ) \cdot {x}_{0} ( i , j )$$

subject to a set of constraints. The example constraints of FIG. 7 are based on a matrix x1, which is a Boolean matrix representing the different possible household sizes that can be assigned to the different RPD households, and a size matrix S1, which represents the values of the different possible household sizes.

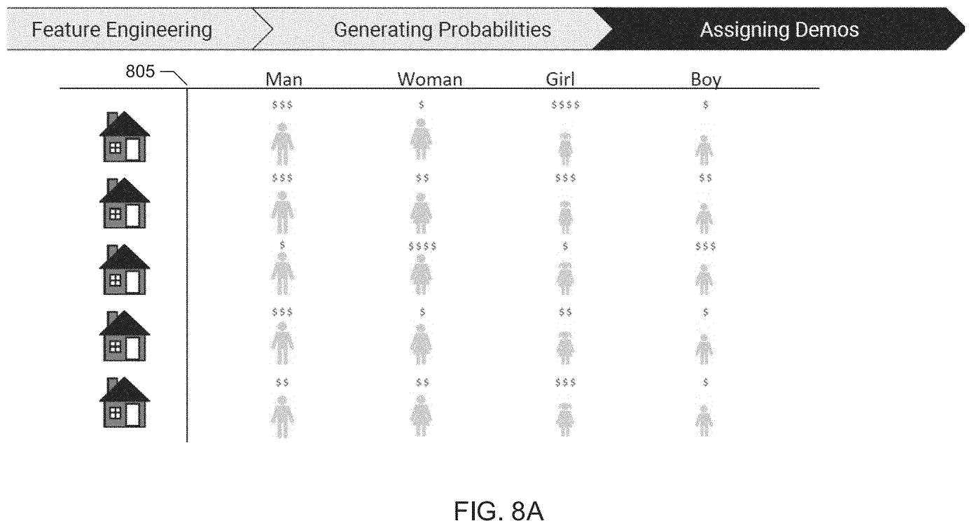

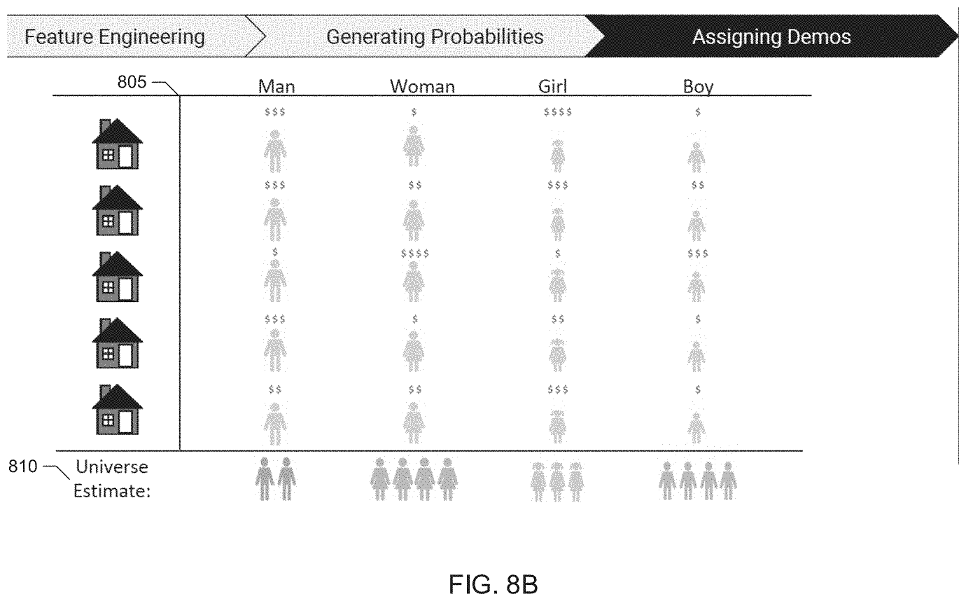

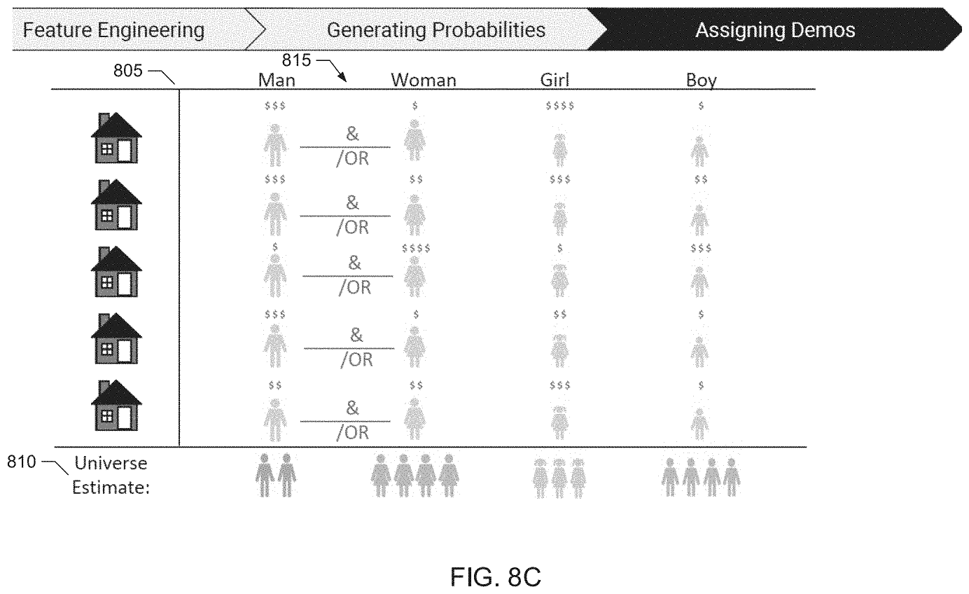

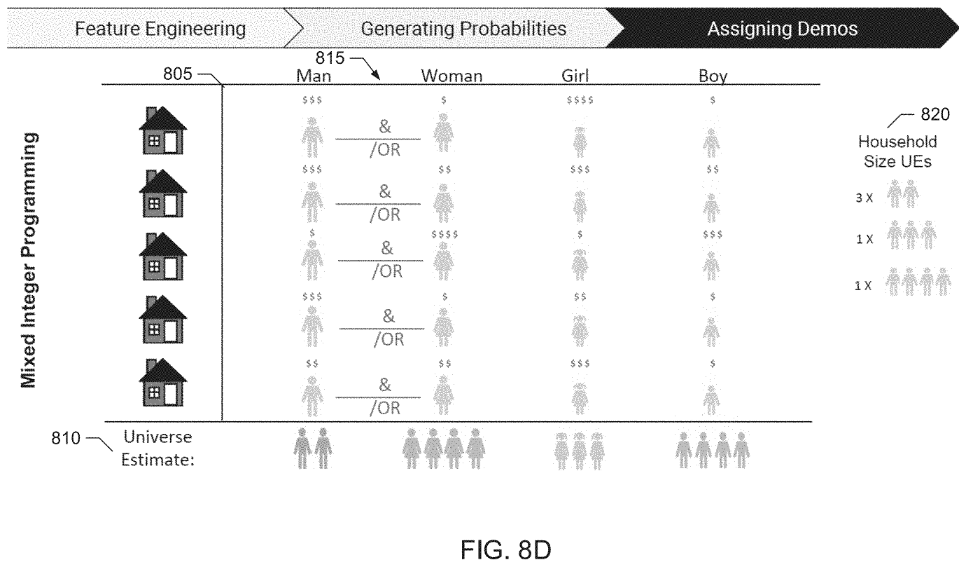

FIGS. 8A-E illustrate an example operation of the household demographic assignment engine 340 implemented by the pseudocode 700 of FIG. 7 to assign demographic categories to RPD households by solving the above expression subject to the example constraints of FIG. 7. FIG. 8A illustrates an example CO cost matrix 805 having 5 rows representing 5 RPD households for which demographic categories are to be assigned, and 4 columns representing 4 possible demographic categories that could be assigned to respective ones of the RPD households. The cost values for the different possible demographic categories are represented by dollar signs ($) in FIG. 8A, with more dollar signs representing a higher cost. In the illustrated example, costs included in the CO cost matrix 805 are inversely proportional to the corresponding estimated demographic classification probabilities (also referred to as the predicted demographic target variables above) output from the output layer 525 of the demographic prediction neural network 335 for the given household and demographic category combinations.

Referring to FIGS. 7 and 8A-E, the example constraints of FIG. 7 include a first constraint 705, which specifies that the overall sums of the different demographic categories assigned to all RPD households is to equal the known universe estimates (UEs) for the respective different demographic categories (e.g., within a tolerance level represented by the variable “slack”). An example of the first constraint 705 is illustrated in FIG. 8B, in which the sums of the respective demographic categories assigned over the 5 households are to equal the respective example UEs 810 for the different demographic categories (e.g., which may be obtained from the service provider(s) providing the RPD and stored in the constraint database 345). For example, in FIG. 8B, the first constraint 705 specifies that the number of households to be assigned the demographic category of “man” is to equal the UE of 2 for that demographic category, the number of households to be assigned the demographic category of “woman” is to equal the UE of 4 for that demographic category, the number of households to be assigned the demographic category of “girl” is to equal the UE of 3 for that demographic category, and the number of households to be assigned the demographic category of “man” is to equal the UE of 2 for that demographic category.

The example constraints of FIG. 7 include a second constraint 710, which specifies that there must be at least one adult demographic category assigned to each RPD household. An example of the second constraint 710 is illustrated in FIG. 8B, in which each RPD household is constrained to include the demographic category of “man” and/or the demographic category of “woman” (which is represented by reference numeral 815).

The example constraints of FIG. 7 include a third constraint 715, which specifies that the overall numbers of the different possible household sizes assigned to all RPD households is to equal the known universe estimates (UEs) for the different possible household sizes (e.g., within a tolerance level represented by the variable “slack”). An example of the third constraint 715 is illustrated in FIG. 8D, in which the numbers of the respective possible household sizes assigned over the 5 households are to equal the respective example UEs 820 for the different possible household sizes (e.g., which may be obtained from the service provider(s) providing the RPD and stored in the constraint database 345). For example, in FIG. 8D, the third constraint 715 specifies that the number of households containing two people is to equal the UE of 3 for that household size, the number of households containing three people is to equal the UE of 1 for that household size, and the number of households containing four people is to equal the UE of 1 for that household size.

The example constraints of FIG. 7 include a fourth constraint 720, which specifies that each RPD household is to be assigned just one of the possible household sizes, and a fifth constraint 725, which specifies that the number of different demographic categories assigned to a given RPD household is to equal the household size assigned to that household. FIG. 8E illustrates resulting example demographic category assignments 825 determined by the household demographic assignment engine 340 implemented with the pseudocode 700 of FIG. 7 and given the example constraints 705-725 as illustrated in FIGS. 8A-D. In the example of FIG. 8E, the household demographic assignment engine 340 implemented with the pseudocode 700 solves the expression provided above (and in FIG. 7) subject to the aforementioned constraints to assign: (1) the demographic categories of“woman” and “boy” to the first RPD household, (2) the demographic categories of “woman” and “boy” to the second RPD household, (3) the demographic categories of “man” and “girl” to the third RPD household, (4) the demographic categories of “woman,” “girl” and “boy” to the fourth RPD household, and (5) the demographic categories of“man,” “woman,” “girl” and “boy” to the fifth RPD household. As can be seen in the examples of FIGS. 8A-E, the demographic category assignments 825 satisfy the specified constraints.

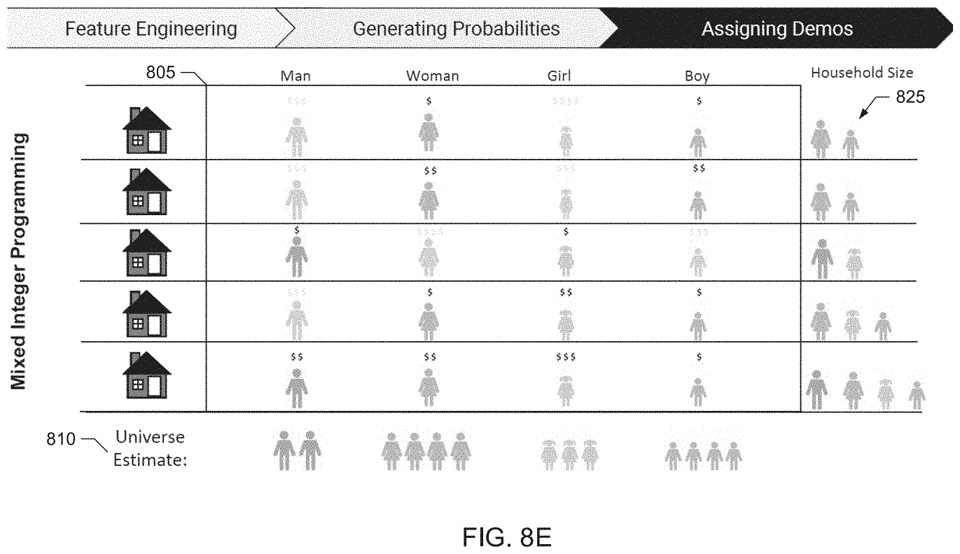

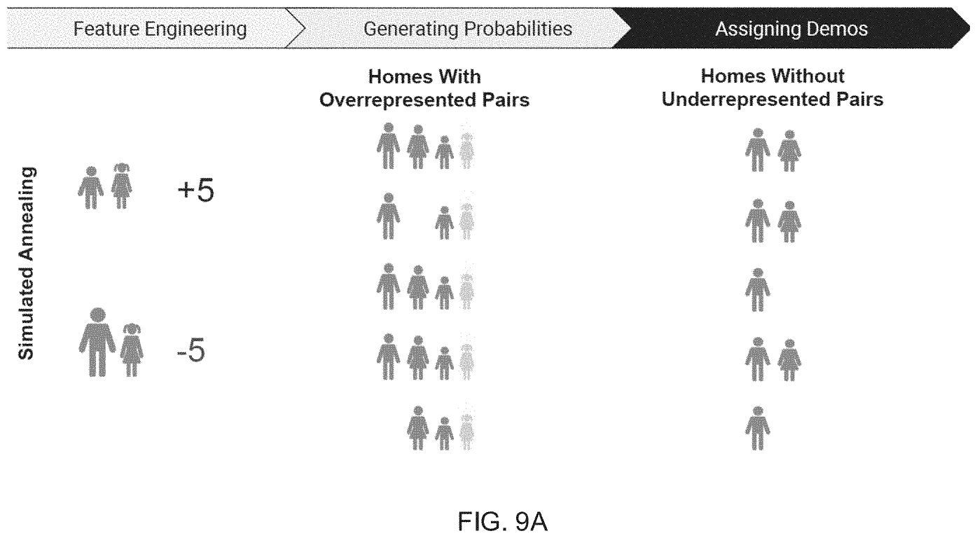

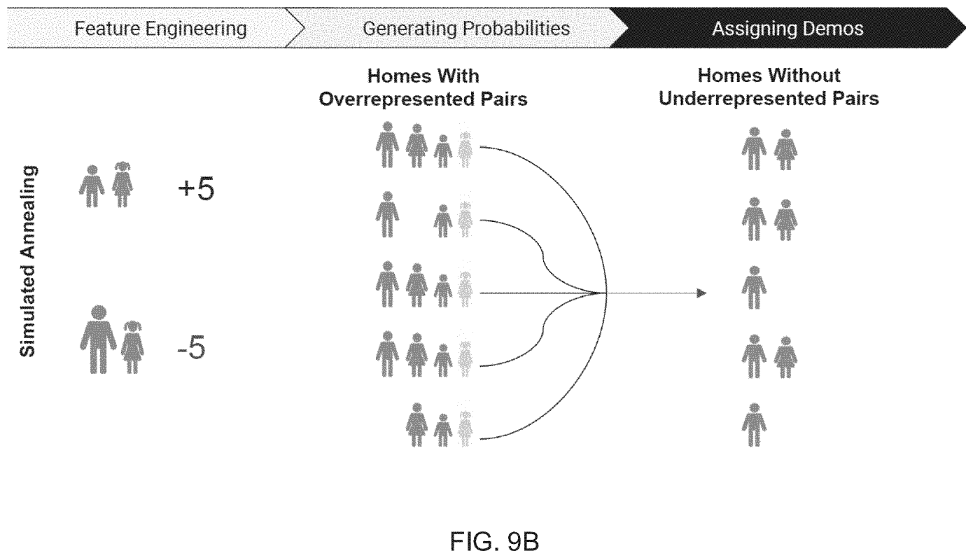

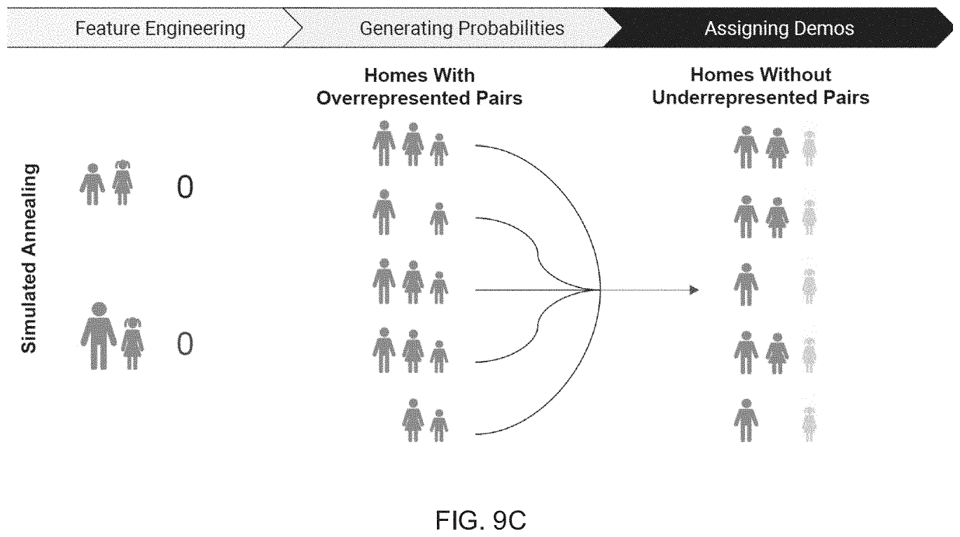

In some examples, the household demographic assignment engine 340 implements simulated annealing to further adjust the demographic category assignments made for the RPD households. An example operation of the household demographic assignment engine 340 to perform simulated annealing is illustrated in FIGS. 9A-C. Turning to FIG. 9A, in the illustrated example, the household demographic assignment engine 340 has performed an initial household demographic assignment in which demographic category assignments containing both “boy” and “girl” are overrepresented relative to UE constraints for that combination of demographic categories by five households, and demographic category assignments containing both “man” and “girl” are underrepresented relative to UE constraints for that combination of demographic categories by five households. As shown in FIGS. 9B-C, the household demographic assignment engine 340 can perform simulated annealing to identify five households containing the overrepresented demographic category assignment of both “boy” and “girl” (see FIG. 9B) and shift the demographic category assignments of “girl” from those households to five households that do not have a demographic category assignment of both “man” and “girl” (see FIG. 9C). The result is revised demographic category assignments that correct for the overrepresentation and underrepresentation illustrated in FIG. 9A.

In some examples, the household demographic assignment engine 340 breaks the demographic assignment problem illustrated in FIG. 7 into several smaller batches to reduce processing and memory requirements. For example, if a market contains are 100,000 RPD households for which demographic categories are to be assigned, the household demographic assignment engine 340 can break the assignment problem into 100 groups of 1,000 homes, or 1,000 groups of 100 homes, etc. In such examples, the pseudocode 700 of FIG. 7 is adjusted such that the constraints related to universe estimates (UEs) are scaled down by the ratio of the number of RPD households included in the batched groups to the total number of RPD households, and the pseudocode 700 is applied to perform demographic category assignment for each batched group. However, because such simple scaling may not result in solvable constraints for all batched groups, the tolerance levels (e.g., represented by “slack” in FIG. 7) are included to increase the likelihood that each batched group will have a solvable demographic assignment.

Returning to FIG. 3, the neural-network-based demographic estimation system 300 includes the ratings calculator 350 to determine ratings data and/or other audience metrics by using the household demographic assignments determined by the household demographic assignment engine 340 for the RPD households to augment/combine the panel tuning data from the panelist database 315, which already has associated demographic data, with the RPD tuning data from the RPD database 325.

Examples disclosed above in connection with FIGS. 3, 4A-B, 5, 6A-C, 7, 8A-E and 9A-C implement neural network processing of set-top box return path data to assign one or more demographic categories to RPD households. In other words, such disclosed examples assign demographic presence to households to satisfy known, or estimated, UEs for respective demographic categories (e.g., from panel data and/or other audience measurement techniques). Some examples disclosed above also combine the demographic presence categories assigned to the RPD households with known, or estimated, UEs of numbers of individual household members associated with the RPD households (e.g., from panel data and/or other audience measurement techniques) to assign individual household members (e.g., virtual household members) to respective ones of the RPD households to meet the UE targets.

Further examples disclosed herein assign long term visitors (e.g., virtual long term visitors) as well as household members (also referred to as primary household members, e.g., virtual members for whom the household is their residence) to the RPD households to satisfy the demographic presence categories assigned to the households and known, or estimated, UEs of numbers of long term visitors associated with the RPD households (e.g., from panel data and/or other audience measurement techniques). At a high-level, some such disclosed visitor assignment techniques modify the targets (e.g., UEs) used by the example demographic category assignment techniques disclosed above to incorporate visitors in the counts for the numbers of people in the different demographic classifications being used. By modifying the input targets, the example demographic category assignment techniques disclosed above (also referred to as household demographic assignment model (HDAM) techniques) are able to predict total household compositions that include (but at this point do not distinguish among) both household members and long term visitors. Disclosed example visitor assignment techniques also include creating visitor vectors that conform to provided visitor distribution targets (e.g., from panel data and/or other audience measurement techniques), and then assigning the visitor vectors to RPD households having predicted total household compositions that are able to support the sizes and demographic compositions of the respective visitor vectors.

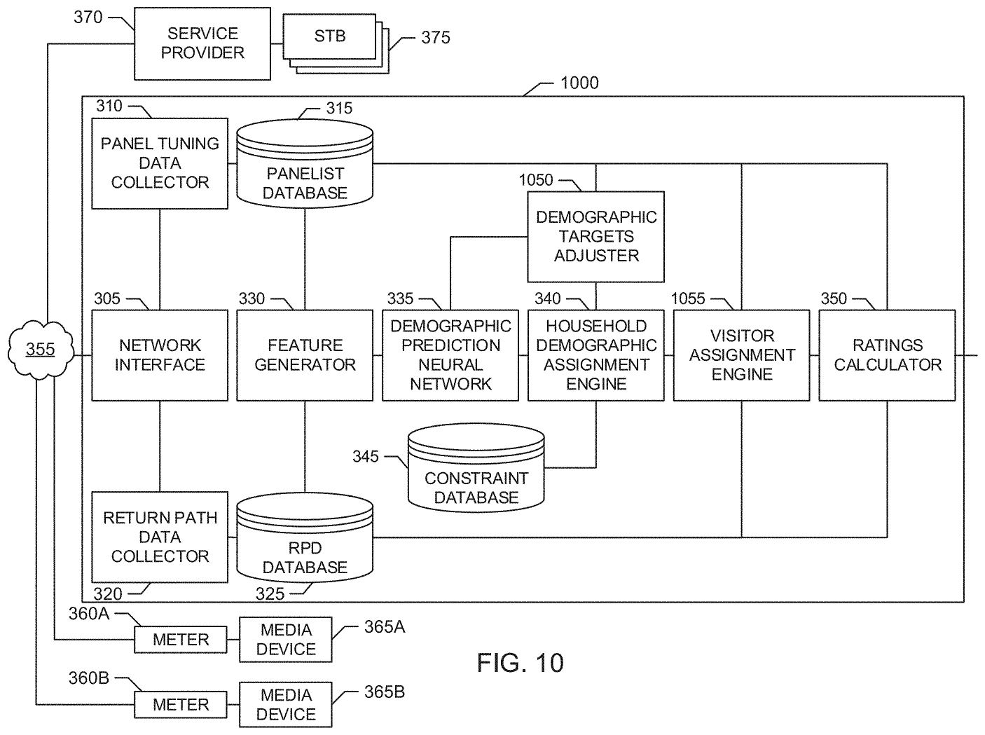

A block diagram of an example neural-network-based demographic estimation system structured to implement the processing flows of FIGS. 1 and 2 to estimate household demographics for primary household members and long term visitors from set-top box return path data in accordance with teachings of this disclosure is illustrated in FIG. 10. The example neural-network-based demographic estimation system 1000 includes the example network interface 305, the example panel tuning data collector 310, the example panelist database 315, the example RPD data collector 320, the example RPD database 325, the example feature generator 330, the example demographic prediction neural network 335, the example household demographic assignment engine 340, the example constraint database 345, and the example ratings calculator 350 from the example neural-network-based demographic estimation system 300, which are described in further detail above in connection with FIG. 3. The example neural-network-based demographic estimation system 1000 also includes an example demographic targets adjuster 1050 and an example visitor assignment engine 1055.

In the illustrated example of FIG. 10, the demographic target adjuster 1050 adjusts the UE demographic targets to account for long term visitor data. As disclosed above in connection with the neural-network-based demographic estimation system 300, the HDAM technique of the neural-network-based demographic estimation system 300 utilizes UEs of the respective different demographic categories, also referred to as demographic presence UEs, which specify the total number of RPD homes that are to be assigned respective ones of the different demographic categories. In some examples, the demographic presence UEs are determined based on (i) a total target UE for the number of RPD household members (e.g., determined or estimated from panel data, provider data and/or other audience measurement techniques) and (ii) demographic distribution data (e.g., from panel data, such as Nielsen People Monitoring (NPM) data), which is used to determine UEs for total numbers of RPD household members in each demographic category. The UEs for the total numbers of RPD household members in each demographic category are then used with demographic presence UEs obtained from the panel data (e.g., NPM data) to determine the demographic presence UEs for the HDAM technique. However, such unmodified UE targets do not account for the presence of long term visitors. But, panel data (e.g., NPM data) can provide information about the demographics (e.g., ages and genders) of those labeled long term visitors. This information is used by the example demographic targets adjuster 1050 to compute a scale vector, which includes elements referred to as scale factors, to apply to the UEs for the number of RPD household members in the different demographic categories. Each scale factor corresponds to a respective demographic category (e.g., age-gender bucket). Using the subscript i to denote the i^{th} demographic category, the scale factors for the scale vector are determined based on the fraction of total people in the demographic category (e.g., age-gender bucket) i that are long term visitors, which can be seen in Equation 1 below.

fi=Nv,i/(Np,i+Nv,i) (Equation 1)

In Equation 1 above, N_{v,i} is the number of visitors in the demographic category (e.g., age-gender bucket) i (e.g., obtained from panel/NPM data), and N_{p,i} is the number of primary household members in the demographic category (e.g., age-gender bucket) i (e.g., obtained from panel/NPM data). The scale factor for the demographic category i is found to be:

Si=1−fi=Np,i/(Np,i+Nv,i) (Equation 2).

The scale factor Sᵢ in Equation 2 above is used by the example demographic target adjuster 1050 to adjust (e.g., divide) the UE for the total number of RPD household members in demographic category i, which is used as the demographic presence UE for demographic category i for the HDAM technique, as described above in connection with the neural-network-based demographic estimation system 300. In this way, the example demographic target adjuster 1050 adjusts the presence UEs used by the HDAM technique to account for the presence of long term visitors.

In some examples, the demographic targets adjuster 1050 may adjust the demographic targets using target rates instead of the scale factors described above. In some such examples, it is assumed that the HDAM technique disclosed in the technique of the neural-network-based demographic estimation system 300 has been further modified to assign individual household members to the RPD households based on the demographic categories (e.g., demographic presence) assigned RPD households, as disclosed above. The demographic targets adjuster 1050 determines the target rates of occurrences of different numbers of people in the different demographic categories (e.g., as determined from panel data and/or other audience measurement techniques). The example HDAM technique disclosed above can be further modified to scale the demographic categories (e.g., demographic presence) assigned to RPD households by the target rates found by the example demographic targets adjuster 1050 to assign individual members to the RPD households in accordance with those targets. For example, if the target rates of occurrence of a first demographic category are 80% that one person in a household will be in that category, 15% that two people in a household will be in that same category, and 5% that three people in a household will be in that category, then a modified HDAM technique can select RPD households that have been assigned the first demographic category such that 80% of those households will be assigned one individual in that category, 15% of those households will be assigned two individuals in that category, and 5% of those homes will be assigned three individuals in that category.

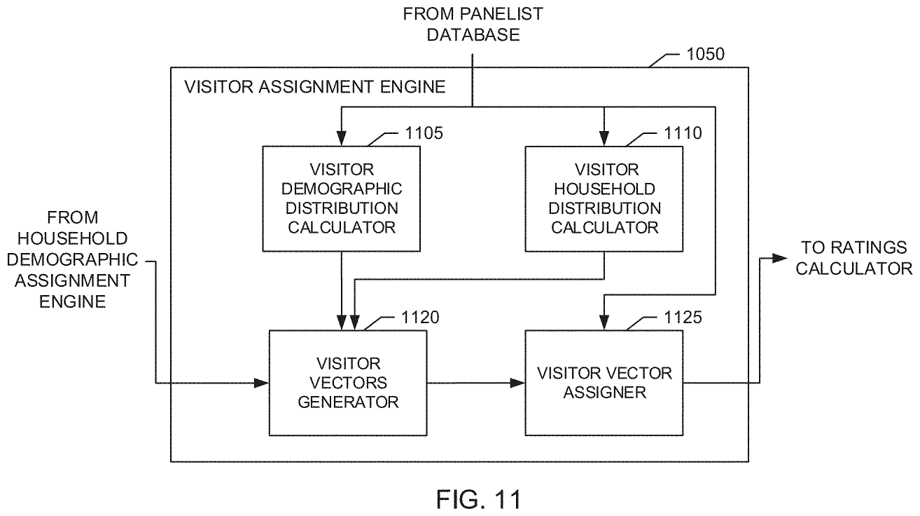

The visitor assignment engine 1055 of the illustrated example of FIG. 10 operates to distinguish the visitors from the primary household members in the total household compositions assigned to the RPD households based on the updated UE targets. In some examples, the target aggregate level visitor population and demographic (e.g., age-gender) distributions are obtained from panel data in the panelist database 315. The example visitor assignment engine 1055 receives the output of the household demographic assignment engine 340, with the updated UE targets from the example demographic target adjuster 1050, for a given RPD household, which this output can be thought of as a vector containing the total numbers of visitors and primary household members assigned to the RPD household for each possible demographic category. The example visitor assignment engine 1055 constructs a target population of visitors having the target demographics for assignment to the RPD households. The example visitor assignment engine 1055 is discussed in further detail below in connection with FIG. 11.

FIG. 11 is a block diagram of the example visitor assignment engine 1050 from the example neural-network based demographic estimation system of FIG. 10. The example visitor assignment engine 1050 includes an example visitor demographic distribution calculator 1105, an example visitor household distribution calculator 1110, an example visitor vectors generator 1120, and an example visitor vector assigner 1125.

In the illustrated example of FIG. 11, the visitor vectors generator 1120 generates a set of visitor vectors that satisfy the set of visitor demographic targets. In examples disclosed herein, the example visitor vectors generator 1120 iteratively generates visitor vectors representative of the visitor demographic compositions to be assigned to the RPD households. The example visitor vectors generator 1120 generates the visitor vectors based on inputs including percentages of long term visitors in each demographic category and the percentages of homes having respective different possible numbers of visitors. In the illustrated example of FIG. 11, the visitor demographic distribution calculator 1105 determines respective percentages of long term visitors in ones of the one or more demographic categories based on the panel data from the panelist database 315. The visitor household distribution calculator 1110 of the illustrated example of FIG. 11 determines respective percentages of the RPD households having corresponding numbers of long-term visitors based on the panel data from the panelist database 315.

The visitor vector assigner 1125 of the illustrated example of FIG. 11 assigns the visitor vectors to RPD households based on respective probabilities that corresponding ones of the RPD households include at least one visitor. The example visitor vector assigner 1125 assigns the visitor vectors generated by the visitor vector generator 1120 to valid RPD households iteratively. The example visitor vector assigner 1125 assigns the visitor vectors based on the household demographic assignments made by the example household demographic assignment engine 340, using the updated demographic targets from the example demographic targets adjuster 1050. The example visitor vector assigner 1125 is also provided to calculate the probabilities that the RPD households have at least one visitor. The example visitor vector assigner 1125 determines which RPD households are valid households for an example visitor vector and creates a set of possible RPD households. In the illustrated example, the visitor vector assigner 1125 selects the RPD household that has the highest probability that the respective RPD household has at least one visitor from the set of possible RPD households, and the visitor vector assigner 1125 assigns the visitor vector to the selected RPD household. In the illustrated example, once a visitor vector has been assigned to the selected RPD household, the visitor vector assigner 1125 removes the selected RPD household from the set of available RPD households so that it is no longer considered for further visitor vector assignments. In the illustrated example, the RPD households are constrained to only having one visitor vector assignment. However, in some examples, the RPD household may be allowed to have multiple visitor vector assignments. In some examples, the visitor vector assigner 1125 may not remove the selected RPD household from the set of available RPD households to allow multiple visitor vectors to be assigned to the RPD household. The example visitor vector assigner 1125 iteratively assigns visitor vectors to RPD households until there are no more visitor vectors left. In some examples, if not all visitor vectors are able to be assigned to RPD households (e.g., because at some point no remaining RPD households are valid for a given visitor vector), the example visitor vector generator 1120 collects the remaining, unassigned visitor vectors, creates a new visitor pool from the remaining visitors represented in the unassigned visitor vectors to generate new visitor vectors for the example visitor vector assigner 1125.

The output of the example visitor vector assigner 1125 includes demographic assignments for primary household members and long term visitors for the different RPD households. This output is provided by the example visitor assignment engine 1055 to the example ratings calculator 350, where the ratings calculator 350 performs calculations based on the output that includes both primary household members and long term visitors.

In some examples, the visitor vector assigner 1125 can be simplified under a constraint that only one visitor is to be assigned to a given RPD household. Such a simplification further assumes that the number of visitors is less than or equal to the number of RPD households. In such an example, the example visitor vector assigner selects one of the demographic categories (e.g., one of the age-gender buckets) to use in assigning the visitor vectors. The example visitor vector assigner 1125 identifies the set of RPD households that are candidates for a visitor in the selected demographic category (e.g., selected age-gender bucket) and orders that set of RPD households based on the probability of having a visitor in that demographic category (e.g., age-gender bucket). The example visitor vector assigner 1125 selects the RPD household with the highest visitor probability and labels one of the people assigned to that RPD households in that demographic category (e.g., age-gender bucket) as a long term visitor. In such an example, the example visitor vector assigner iterates until all visitors in the selected demographic category (e.g., age-gender bucket) have been placed in RPD households and over the different demographic categories until the target number of visitors have been assigned to the RPD homes.

While an example manner of implementing the neural-network-based demographic estimation system 300 is illustrated in FIG. 3, one or more of the elements, processes and/or devices illustrated in FIG. 3 may be combined, divided, re-arranged, omitted, eliminated and/or implemented in any other way. Further, the example network interface 305, the example panel tuning data collector 310, the panelist database 315, the example RPD data collector 320, the example RPD database 325, the example feature generator 330, the example demographic prediction neural network 335, the example household demographic assignment engine 340, the example constraint database 345, the example ratings calculator 350 and/or, more generally, the example neural-network-based demographic estimation system 300 of FIG. 3 may be implemented by hardware, software, firmware and/or any combination of hardware, software and/or firmware. Thus, for example, any of the example network interface 305, the example panel tuning data collector 310, the panelist database 315, the example RPD data collector 320, the example RPD database 325, the example feature generator 330, the example demographic prediction neural network 335, the example household demographic assignment engine 340, the example constraint database 345, the example ratings calculator 350 and/or, more generally, the example neural-network-based demographic estimation system 300 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate arrays (FPGAs) and/or field programmable logic device(s) (FPLD(s)). When reading any of the apparatus or system claims of this patent to cover a purely software and/or firmware implementation, at least one of the example neural-network-based demographic estimation system 300, the example network interface 305, the example panel tuning data collector 310, the panelist database 315, the example RPD data collector 320, the example RPD database 325, the example feature generator 330, the example demographic prediction neural network 335, the example household demographic assignment engine 340, the example constraint database 345 and/or the example ratings calculator 350 is/are hereby expressly defined to include a non-transitory computer readable storage device or storage disk such as a memory, a digital versatile disk (DVD), a compact disk (CD), a Blu-ray disk, etc. including the software and/or firmware. Further still, the example neural-network-based demographic estimation system 300 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

While an example manner of implementing the neural-network-based demographic estimation system 1000 is illustrated in FIGS. 10 and 11, one or more of the elements, processes and/or devices illustrated in FIGS. 10 and 11 may be combined, divided, re-arranged, omitted, eliminated and/or implemented in any other way. Further, the example network interface 305, the example panel tuning data collector 310, the panelist database 315, the example RPD data collector 320, the example RPD database 325, the example feature generator 330, the example demographic prediction neural network 335, the example household demographic assignment engine 340, the example constraint database 345, the example demographic targets adjuster 1050, the example visitor assignment engine 1055, the example ratings calculator 350 and/or, more generally, the example neural-network-based demographic estimation system 1000 of FIG. 10 may be implemented by hardware, software, firmware and/or any combination of hardware, software and/or firmware. Thus, for example, any of the example network interface 305, the example panel tuning data collector 310, the panelist database 315, the example RPD data collector 320, the example RPD database 325, the example feature generator 330, the example demographic prediction neural network 335, the example household demographic assignment engine 340, the example constraint database 345, the example demographic targets adjuster 1050, the example visitor assignment engine 1055, the example ratings calculator 350 and/or, more generally, the example neural-network-based demographic estimation system 1000 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate arrays (FPGAs) and/or field programmable logic device(s) (FPLD(s)). When reading any of the apparatus or system claims of this patent to cover a purely software and/or firmware implementation, at least one of the example neural-network-based demographic estimation system 1000, the example network interface 305, the example panel tuning data collector 310, the panelist database 315, the example RPD data collector 320, the example RPD database 325, the example feature generator 330, the example demographic prediction neural network 335, the example household demographic assignment engine 340, the example constraint database 345, the example demographic targets adjuster 1050, the example visitor assignment engine 1055 and/or the example ratings calculator 350 is/are hereby expressly defined to include a non-transitory computer readable storage device or storage disk such as a memory, a digital versatile disk (DVD), a compact disk (CD), a Blu-ray disk, etc. including the software and/or firmware. Further still, the example neural-network-based demographic estimation system 1000 may include one or more elements, processes and/or devices in addition to, or instead of, those illustrated in FIGS. 10 and 11, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

In examples disclosed herein, the example function generator 330 implements means for generating features from return path data. The example neural network 335 implements means for processing the features generated from the return path data to predict demographic classification probabilities for return path data households. The example demographic assignment engine 340 implements means for assigning one or more demographic categories to respective ones of return path data households. The example visitor assignment engine 1055 implements means for assigning virtual visitors to at least a subset of the respective ones of the return path data households. The example demographic targets adjuster 1050 implements means for updating demographic targets to account for the presence of visitors. The example visitor vector generator 1120 implements means for generating a visitor vector containing a first number of visitors. The example visitor vector assigner 1125 implements means for assigning the visitor vector to a first one of the return path data households. The example visitor demographic distribution calculator 1105 implements means for determining respective percentages of visitors in ones of the one or more demographic categories. The example visitor household distribution calculator 1110 implements means for determining respective percentages of the return path data households having corresponding numbers of visitors.

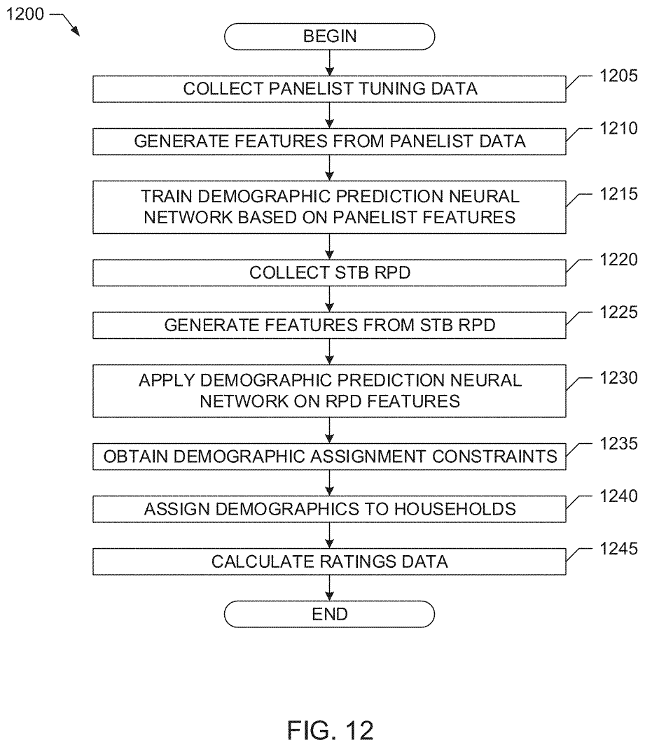

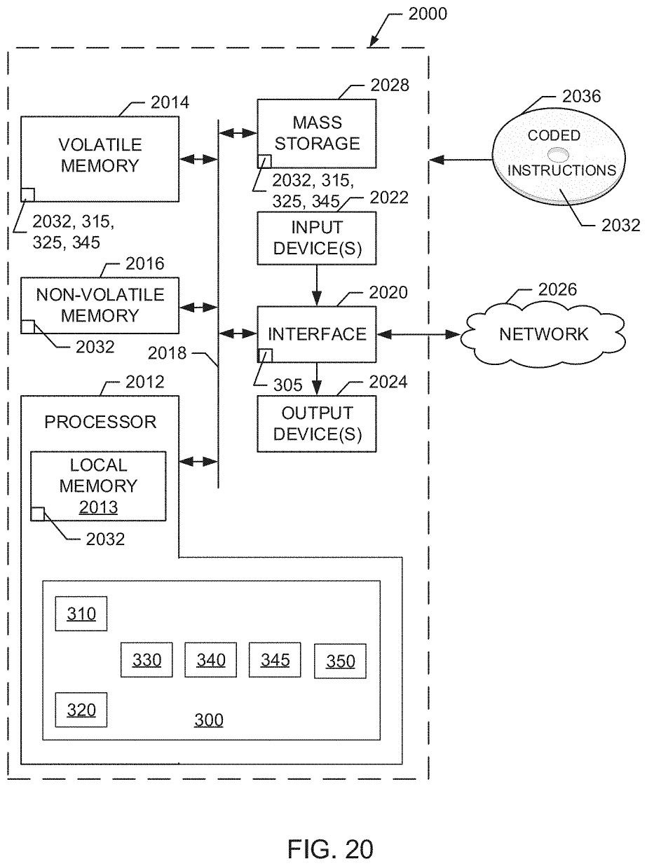

A flowchart representative of example hardware logic, machine readable instructions, hardware implemented state machines, and/or any combination thereof for implementing the example neural-network-based demographic estimation system 300 is shown in FIG. 12. In this example, the machine readable instructions may be one or more executable programs or portion(s) thereof for execution by a computer processor, such as the processor 2012 shown in the example processor platform 2000 discussed below in connection with FIG. 20. The one or more programs, or portion(s) thereof, may be embodied in software stored on a non-transitory computer readable storage medium such as a CD-ROM, a floppy disk, a hard drive, a DVD, a Blu-ray Disk™, or a memory associated with the processor 2012, but the entire program or programs and/or parts thereof could alternatively be executed by a device other than the processor 2012 and/or embodied in firmware or dedicated hardware. Further, although the example program(s) is(are) described with reference to the flowchart illustrated in FIG. 12, many other methods of implementing the example neural-network-based demographic estimation system 300 may alternatively be used. For example, with reference to the flowchart illustrated in FIG. 12, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

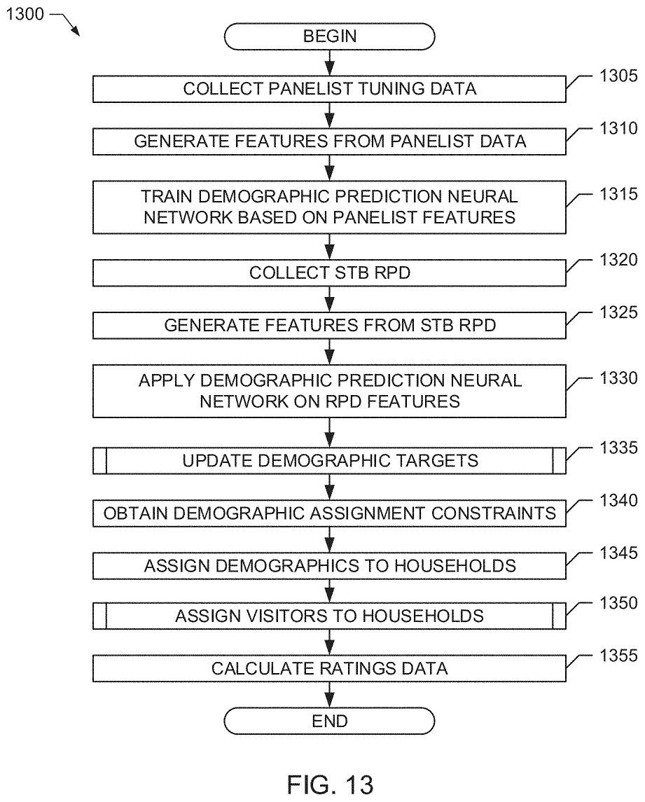

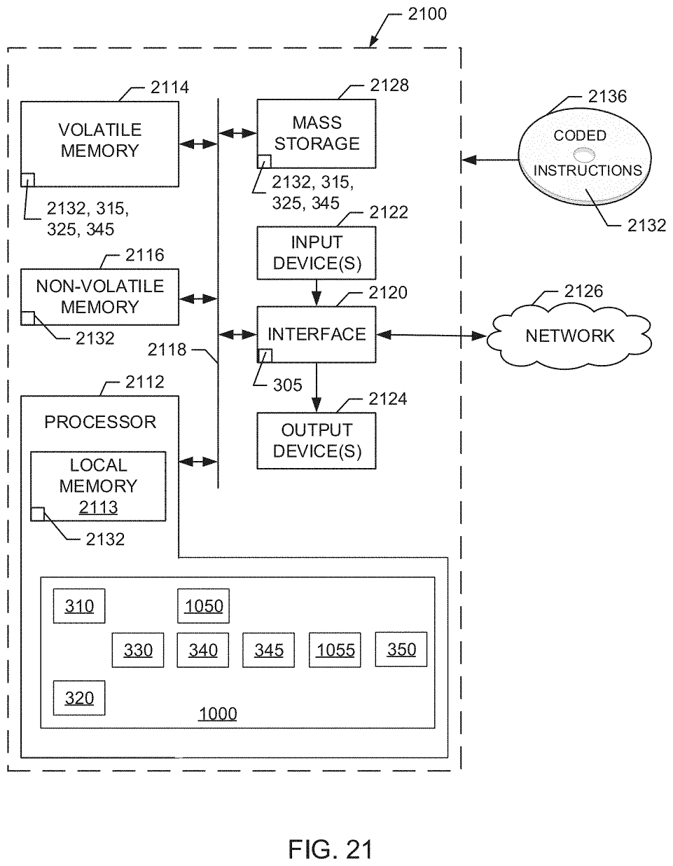

Flowcharts representative of example hardware logic, machine readable instructions, hardware implemented state machines, and/or any combination thereof for implementing the example neural-network-based demographic estimation system 1000 are shown in FIGS. 13, 14, 15, 16, 17, 18, and 19. In this example, the machine readable instructions may be one or more executable programs or portion(s) thereof for execution by a computer processor, such as the processor 2012 shown in the example processor platform 2100 discussed below in connection with FIG. 21. The one or more programs, or portion(s) thereof, may be embodied in software stored on a non-transitory computer readable storage medium such as a CD-ROM, a floppy disk, a hard drive, a DVD, a Blu-ray Disk™, or a memory associated with the processor 2100, but the entire program or programs and/or parts thereof could alternatively be executed by a device other than the processor 2100 and/or embodied in firmware or dedicated hardware. Further, although the example program(s) is(are) described with reference to the flowcharts illustrated in FIGS. 13, 14, 15, 16, 17, 18, and 19, many other methods of implementing the example neural-network-based demographic estimation system 1000 may alternatively be used. For example, with reference to the flowcharts illustrated in FIGS. 13, 14, 15, 16, 17, 18, and 19, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, etc. in order to make them directly readable and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein. In another example, the machine readable instructions may be stored in a state in which they may be read by a computer, but require addition of a library (e.g., a dynamic link library), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

As mentioned above, the example processes of FIGS. 12, 13, 14, 15, 16, 17, 18, and/or 19 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. Also, as used herein, the terms “computer readable” and “machine readable” are considered equivalent unless indicated otherwise.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

An example program 1200 that may be executed to implement the example neural-network-based demographic estimation system 300 of FIG. 3 is represented by the flowchart shown in FIG. 12. With reference to the preceding figures and associated written descriptions, the example program 1000 of FIG. 12 begins execution at block 1205 at which the example panel tuning data collector 310 of the neural-network-based demographic estimation system 300 collects panelist tuning data, as described above. At block 1210, the example feature generator 330 of the neural-network-based demographic estimation system 300 generates feature vectors (e.g., such as the vectors describes in Table 1 above) for the panelist households based on the collected panelist data, as described above. At block 1215, the feature generator 330 applies the panelist feature vectors generated at block 1210 to the example demographic prediction neural network 335 of the neural-network-based demographic estimation system 300 to train the demographic prediction neural network 335 to predict demographic classification probabilities for the respective panelist homes, as described above.

At block 1220, the example RPD data collector 320 of the neural-network-based demographic estimation system 300 collects RPD tuning data, as described above. At block 1225, the example feature generator 330 generates feature vectors (e.g., such as the vectors describes in Table 1 above) for the RPD households based on the collected RPD tuning data, as described above. At block 1230, the feature generator 330 applies the RPD feature vectors generated at block 1225 to the trained demographic prediction neural network 335 of the neural-network-based demographic estimation system 300 to predict demographic classification probabilities for the respective RPD homes, as described above. At block 1235, the example household demographic assignment engine 340 of the neural-network-based demographic estimation system 300 obtains the demographic assignments constraints from the example constraint database 345, as described above. At block 1240, the example household demographic assignment engine 340 of the neural-network-based demographic estimation system 300 uses the demographic classification probabilities determined at block 1230 to assign demographic categories to respective ones of the RPD households, as described above. At block 1245, the example ratings calculator 350 of the neural-network-based demographic estimation system 300 augments/combines the panel tuning data collected at block 1205, which already has associated demographic data, with the RPD tuning data collected at block 1220 based on the demographic categories assigned to the respective ones of the RPD households at block 1245, as described above.

An example program 1300 may be executed to implement the example neural-network-based demographic estimation system 1000 of FIG. 10 is represented by the flowchart shown in FIG. 13. With reference to the preceding figures and associated written descriptions, the example program 1300 of FIG. 13 begins execution at block 1305 at which the example panel tuning data collector 310 of the neural-network-based demographic estimation system 1000 collects panelist tuning data, as described above. At block 1310, the example feature generator 330 of the neural-network-based demographic estimation system 1000 generates feature vectors (e.g., such as the vectors described in Table 1 above) for the panelist household based on the collected panelist data, as described above. At block 1315, the feature generator 330 applies the panelist feature vectors generated at block 1310 to the example demographic prediction neural network 335 of the neural-network-based demographic estimation system 1000 to train the demographic prediction neural network 335 to predict demographic classification probabilities for the respective panelist homes, as described above.

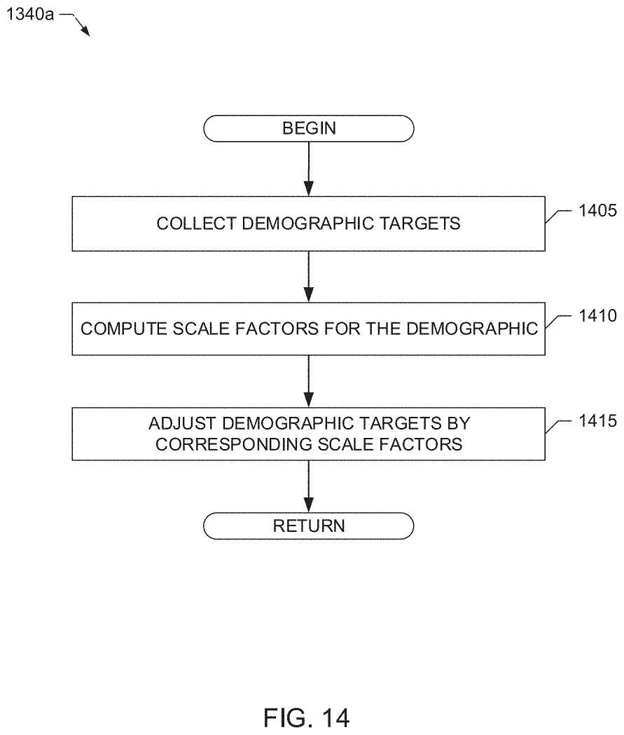

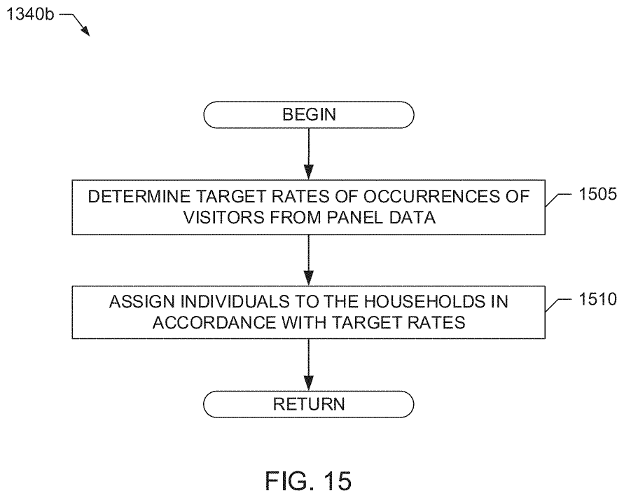

At block 1320, the example RPD data collector 320 of the neural-network-based demographic estimation system 1000 collects RPD tuning data, as described above. At block 1325, the example feature generator 330 generates feature vectors (e.g., such as the vectors describes in Table 1 above) for the RPD households based on the collected RPD tuning data, as described above. At block 1330, the feature generator 330 applies the RPD feature vectors generated at block 1325 to the trained demographic prediction neural network 335 of the neural-network-based demographic estimation system 1000 to predict demographic classification probabilities for the respective RPD households, as described above. At block 1335, the demographic targets adjuster 1050 updates the demographic targets for the household demographic assignment engine 340. As described in further detail below, the example flowcharts of FIGS. 14 and 15 represent example instructions that may be implemented to update the demographic targets to account for long term visitors.

At block 1340, the example household demographic assignment engine 340 obtains the demographic assignment constraints from the example constraint database 345, as described above in connection with FIGS. 7 and 8A-E. At block 1345, the example household demographic assignment engine 340 of the neural-network-based demographic estimation system 1000 uses the demographic classification probabilities determined at block 1330, the demographic assignment constraints obtained at block 1345, and the demographic targets updated at block 1335 to assign demographic categories to respective ones of the RPD households, as described above.

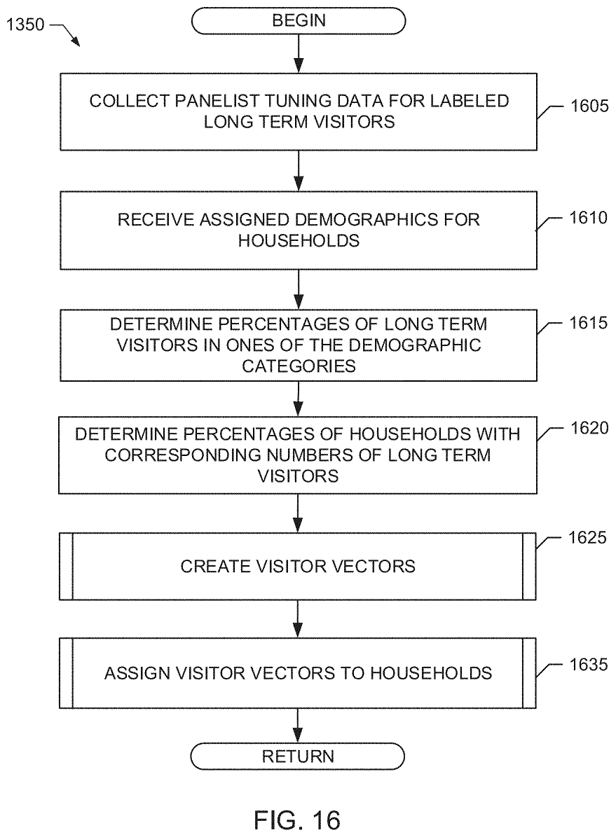

At block 1350, the example visitor assignment engine 1055 assigns the visitors to households. The example visitor assignment engine 1055 uses the demographic category assignments of respective RPD households determined at block 1345 by the example household demographic assignment engine 340 to assign the visitors to the respective RPD households. As described in further detail below, the example flowchart of FIG. 16 represents example instructions that may be implemented to assign the visitors to households.

At block 1355, the example ratings calculator 350 of the neural-network-based demographic estimation system 1000 augments/combines the panel tuning data collected at block 1305, which already has associated demographic data, with the RPD tuning data collected at block 1320 based on the demographic categories assigned to the respective ones of the RPD households at block 1345 and the visitors assigned to the respective ones of the RPD households at block 1350, as described above.

A first example program 1340a may be executed to implement the example demographic targets adjuster 1040 of FIG. 10 and/or the processing at block 1340 of FIG. 13 is represented by the flowchart shown in FIG. 14. With reference to the preceding figures and associated written descriptions, the example program 1340a of FIG. 14 begins execution at block 1405 at which the demographic targets adjuster 1050 collects the demographic targets from the demographic prediction neural network 335. The example demographic prediction neural network 335 provides predicted demographic target variables for primary household members. At block 1410, the example demographic targets adjuster 1050 computes the scale factors for the demographic categories, as described above in connection with FIG. 10. At block 1415, the example demographic targets adjuster 1050 adjusts the demographic targets by the corresponding scale factors found at block 1410. The example demographic targets adjuster 1050 adjusts the demographic targets to account for the presence of long term visitors when used by the example household demographic assignment engine 340. The example program 1340a of FIG. 14 then ends and returns to example program 1300 of FIG. 13.

A second example alternative program 1340b that may be executed to implement the example demographic targets adjuster 1040 of FIG. 10 and/or the processing at block 1340 of FIG. 13 is represented by the flowchart shown in FIG. 15. The example program 1340b of FIG. 15 assumes that the HDAM technique described above is further modified to assign individual household members to the RPD households based on the demographic categories assigned RPD households, as described above in connection with FIG. 10. With reference to the preceding figures and associated written descriptions, the example program 1340b of FIG. 15 begins execution at block 1505 at which the demographic targets adjuster 1050 determines the target rates of occurrences of visitors from the panel data in the panelist database 315. The example demographic targets adjuster 1050 determines the target rates of occurrences of different numbers of visitors in the different demographic categories (e.g., as determined from panel data and/or other audience measurement techniques). For example, the target rates of occurrence of a first demographic category may be 80% that one person in a household with be in that category, 15% that 2 people in a household will be in that same category, and 5% that 3 people in a household will be in that same category.

At block 1510, the example household demographic assignment engine 340 assigns individuals to the households in accordance with the target rates found at block 1505. Referring to the same example above for block 1505, the example household demographic assignment engine 340 selects RPD households that have been assigned the first demographic category such that 80% of those households will be assigned one individual in that category, 15% of those households will be assigned two individuals in that category, and 5% of those homes will be assigned three individuals in that category. In the example program 1340b of FIG. 15, the program 1340b ends and returns to example program 1300 at block 1350 of FIG. 13.

An example program 1350 may be executed to implement the example visitor assignment engine 1055 of FIG. 10 and/or the processing at block 1350 of FIG. 13 is represented by the flowchart shown in FIG. 16. With reference to the preceding figures and associated written descriptions, the example program 1350 of FIG. 16 begins execution at block 1605 at which the visitor assignment engine 1050 collects panelist tuning data for the labeled long term visitors from the panelist database 315. At block 1610, the example visitor vectors generator 1120 receives the assigned demographics for the households determined by the household demographic assignment engine 1055, as described above in connection with FIG. 3.

At block 1615, the example visitor demographic distribution calculator 1105 determines the percentages of long term visitors in ones of the demographic categories. The example visitor demographic distribution calculator 1105 uses the panelist data from the panelist database 315 to determine what percentage of people in each of the demographic categories (e.g. age-gender bucket) are long term visitors. At block 1620, the example visitor household distribution calculator 1110 determines the percentages of households with corresponding numbers of long term visitors. The example visitor household distribution calculator 1110 uses the panelist data from the panelist database 315 to determine the percentage of households that have 1, 2, 3, 4, etc. visitors respectively. For example, the example visitor household distribution calculator 1110 determines what percentage of households have one visitor, and then what percentage of household have two visitors, etc.

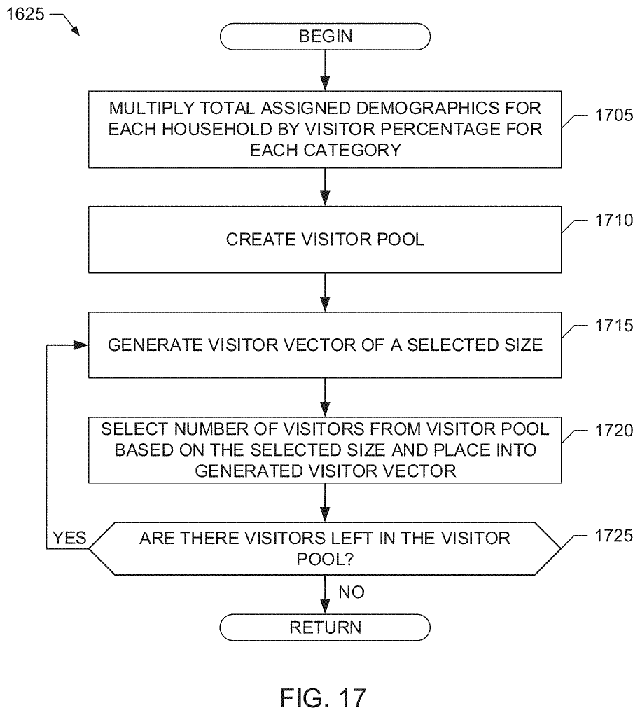

At block 1625, the example visitor vectors generator 1120 creates visitor vectors. The example visitor vectors generator 1120 uses the percentages determined by the example visitor demographic distribution calculator 1105 and the example visitor household distribution calculator 1110 to creates the visitor vectors. As described in further detail below, the example flowchart of FIG. 17 represents example instructions that may be implemented to create the visitor vectors.

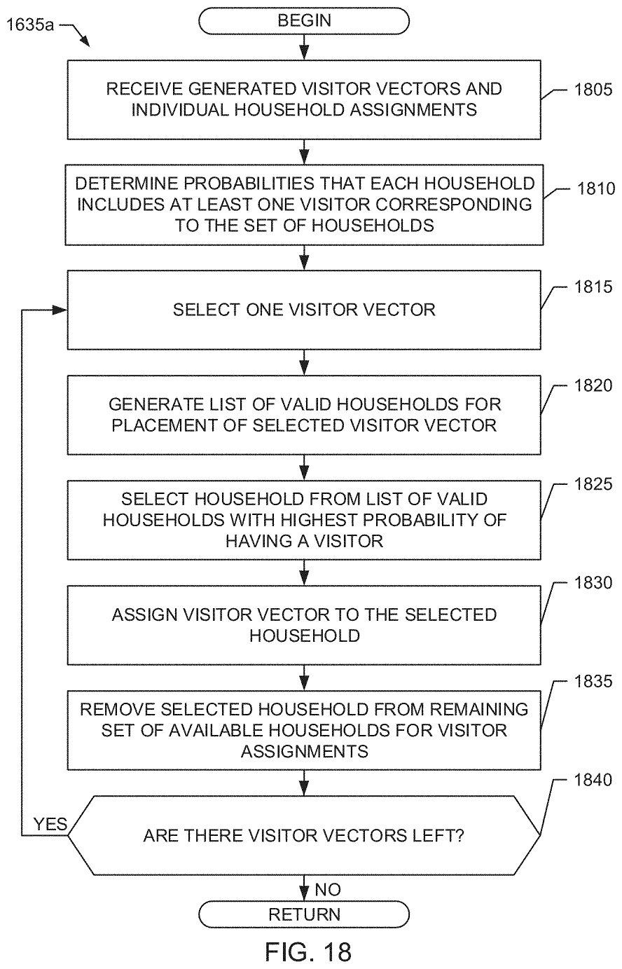

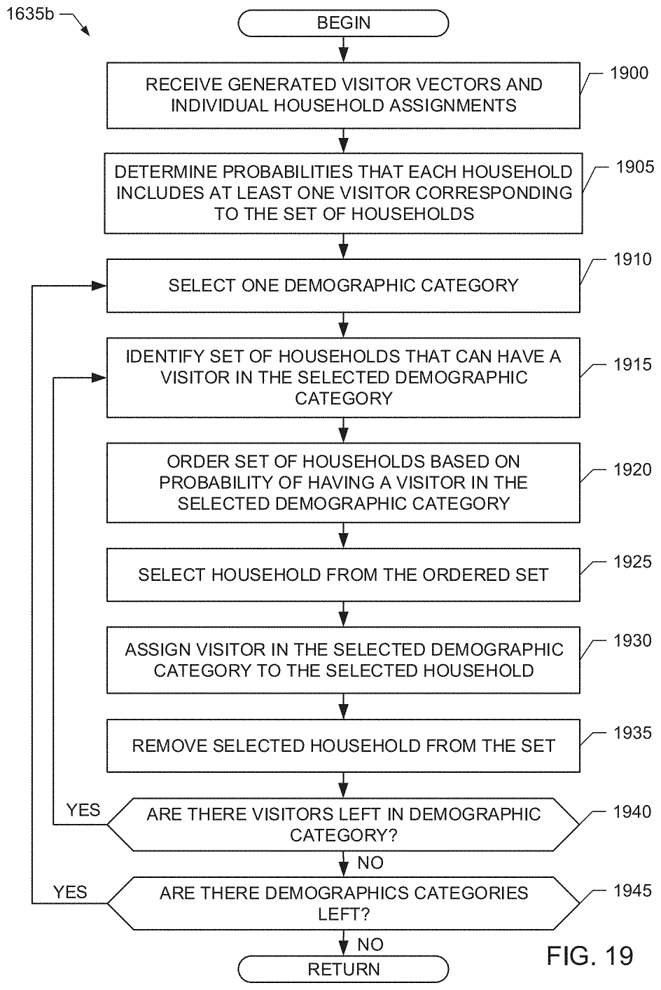

At block 1635, the example visitor vector assigner 1125 assigns visitor vectors to the households. The example visitor vector assigner 1125 uses the panelist data from the panelist database 315 when assigning the visitor vectors created by the visitor vectors generator at bock 1625 to the RPD households. As described in further detail below, the example flowcharts of FIGS. 18 and 19 represent example instructions that may be implemented to assign the visitor vectors to the households. After execution of block 1635, the example program 1350 of FIG. 16 ends and returns to the example program 1300 of FIG. 13.

An example program 1625 may be executed to implement the example visitor vectors generator 1120 of FIG. 11 and/or the processing at block 1625 of FIG. 16 is represented by the flowchart shown in FIG. 17. With reference to the preceding figures and associated written descriptions, the example program 1625 of FIG. 17 begins execution at block 1705 at which the example visitor vector generator 1120 multiplies the total assigned demographics for each household by the visitor percentage for each demographic category. The example visitor vectors generator 1120 multiplies the total number of people in each demographic category assigned to the RPD households, which is determined by the example household demographic assignment engine 340, by the percentage of long term visitors in each demographic category, which is determined by the example visitor demographic distribution calculator 1105. The example visitor vectors generator 1120 determines how many visitors are to be included in each demographic category by performing the above mentioned multiplication.

At block 1710, the example visitor vector generator 1120 creates a visitor pool. Th example visitor vector generator 1120 creates a visitor pool with the total number of expected visitors in each demographic category (e.g., each age-gender bucket). At block 1715, the example visitor vector generator 1120 generates a visitor vector of a selected size. In examples disclosed herein, the selected size is determined based on a random number generator, where the probability of a given size being selected corresponds to the input percentage of households that have that given number (e.g., 1, 2, 3, 4, etc.) of visitors, as determined by the example visitor household distribution calculator 1110. However, other selection methods may additionally or alternatively be used.

At block 1720, the example visitor vector generator 1120 selects a number of visitors from the visitor pool based on the selected size of the visitor vector and places the selected visitors into the generated visitor vector. The example visitor vector generator 1120 selects a number of visitors from the visitor pool corresponding to the selected size of the visitor vector determined at block 1715. The example visitor vector generator 1120 then places the selected visitors into the visitor vector generated at block 1715. At block 1725, the example visitor vector generator 1120 determines if there are any visitors left in the visitor pool. If the example visitor vector generator 1120 determines that there are visitors left in the visitor pool, the example program 1625 of FIG. 17 returns to block 1715 where another visitor vector of a selected size is generated. If the example visitor vector generator 1120 determines that there are no visitors left in the visitor pool, the example program 1625 of FIG. 17 ends and returns to example program 1350 of FIG. 16.

A first example program 1635a may be executed to implement the example visitor vector assigner 1125 of FIG. 11 and/or the processing at block 1635 of FIG. 16 is represented by the flowchart shown in FIG. 18. With reference to the preceding figures and associated written descriptions, the example program 1635a of FIG. 18 begins execution at block 1805 at which the example visitor vector assigner 1125 accesses the generated visitor vectors from the visitor vectors generator 1120 and the individual member assignments to the RPD households (which include, but do not distinguish among, primary household members and visitors), which are determined by the household demographic assignment engine 340, from the visitor vectors generator 1120. The example visitor vector assigner 1125 receives the RPD household assignments that include primary household members and long term visitors due to the updated demographic targets provided by the demographic targets adjuster 1050.

At block 1810, the example visitor vector assigner 1125 determines the probabilities that each household includes at least one visitor corresponding to the set of households. In some examples, the probabilities can be the same for all RPD households such that each home is equally likely to include a visitor. In some examples, the demographic prediction neural network 335 disclosed above can be adapted to output a probability to predict, based on the panelist tuning data from the panelist database 315, the likelihood that a given RPD household has a visitor.

At block 1815, the example visitor vector assigner 1125 selects one visitor vector from the generated visitor vectors from the example visitor vector generator 1120. At block 1820, the example visitor vector assigner 1125 generates a list of valid households for placement of the selected visitor vector. An RPD household is valid if the RPD household is assigned (by the example household demographic assignment engine 340 with the modified demographic targets from the demographic targets adjuster 1050) the same number, or more individuals, in each demographic category than are included in the selected visitor vector. The visitor vector assigner 1125 also ensures that there is at least one individual remains in the adult demographic category assigned to the RPD household that is not a long term visitor.

At block 1825, the example visitor vector assigner 1125 selects a household from the list of valid households determined at block 1815 that has the highest probability of having a visitor determined at block 1810. At block 1830, the example visitor vector assigner 1125 assigns the visitor vector to the selected RPD household. At block 1835, the example visitor vector assigner 1125 removes the selected household from the remaining set of available households for visitor assignments.

At block 1840, the example visitor vector assigner 1125 determines if there are visitor vectors left. If the example visitor vector assigner 1125 determines that there are visitor vectors left, the example program 1635a of FIG. 18 returns to block 1815 where the example visitor vector assigner 1125 selects one visitor vector. If the example visitor vector assigner 1125 determines that there are no visitor vectors left, the example program 1635a of FIG. 18 ends and returns to program 1350 of FIG. 16.

A second alternative program 1635b may be executed to implement the example visitor vector assigner 1125 of FIG. 11 under the constraint that only one visitor is to be assigned to a given household is represented by the flowchart shown in FIG. 19. With reference to the preceding figures and associated written descriptions, the example program 1635b of FIG. 19 begins execution at block 1900 at which the example visitor vector assigner 1125 receives the generated visitor vectors from the visitor vectors generator 1120 and the individual member assignments to the RPD households (which include, but do not distinguish among, primary household members and visitors) determined by the household demographic assignment engine 340 from the visitor vectors generator 1120. The example visitor vector assigner 1125 receives the RPD household assignments that include primary household members and long term visitors due to the updated demographic targets provided by the demographic targets adjuster 1050.

At block 1905, the example visitor vector assigner 1125 determines the probabilities that each household includes at least one visitor corresponding to the set of households. In some examples, the probabilities can be the same for all RPD household such that each home is equally likely to includes a visitor. In some examples, the demographic prediction neural network 335 disclosed above can be adapted to output a probability to predict, based on the panelist tuning data from the panelist database 315, the likelihood that a given RPD household has a visitor.

At block 1910, the example visitor vector assigner 1125 selects one demographic category. At block 1915, the example visitor vector assigner 1125 identifies a set of RPD households that can have a visitor in the selected demographic category. At block 1920, the example visitor vector assigner 1125 orders the set of the RPD households based on the probability of having a visitor in the selected demographic category determined at block 1905. At block 1925, the example visitor vector assigner 1125 selects the household from the ordered set of households. In examples disclosed herein, the example visitor vector assigner 1125 selects the RPD household from the ordered set that has the highest probability of having at least one visitor. At block 1930, the example visitor vector assigner 1125 assigns the visitor of the selected demographic category to the selected RPD household. At block 1935, the example visitor vector assigner 1125 removes the selected household from the ordered set.

At block 1940, the example visitor vector assigner 1125 determines if there are visitors left in the demographic category. If the example visitor vector assigner 1125 determines that there are visitor left in the demographic category, the example program 1635b of FIG. 19 returns to block 1915 where the example visitor vector assigner 1125 identifies a set of households that can have a visitor in the selected demographic category. If the example visitor vector assigner 1125 determines that there are no visitors left in the demographic category, the example program 1635 of FIG. 19 continues to block 1945.

At block 1945, the example visitor vector assigner 1125 determines if there are demographic categories left. If the example visitor vector assigner 1125 determines that there are demographic categories left, the example program 1635 of FIG. 19 returns to block 1910 where the example visitor vector assigner 1125 selects one demographic category. If the example visitor vector assigner 1125 determines that there are no demographic categories left, the example program 1635 of FIG. 19 ends and returns to example program 1350 of FIG. 16.

FIG. 20 is a block diagram of an example processor platform 2000 structured to execute the instructions of FIG. 12 to implement the example neural-network-based demographic estimation system 300 of FIG. 3. The processor platform 2000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 2000 of the illustrated example includes a processor 2012. The processor 2012 of the illustrated example is hardware. For example, the processor 2012 can be implemented by one or more integrated circuits, logic circuits, microprocessors, GPUs, DSPs, or controllers from any desired family or manufacturer. The hardware processor 2012 may be a semiconductor based (e.g., silicon based) device. In this example, the processor 2012 implements the example panel tuning data collector 310, the example RPD data collector 320, the example feature generator 330, the example household demographic assignment engine 340 and the example ratings calculator 350.

The processor 2012 of the illustrated example includes a local memory 2013 (e.g., a cache). The processor 2012 of the illustrated example is in communication with a main memory including a volatile memory 2014 and a non-volatile memory 2016 via a link 2018. The link 2018 may be implemented by a bus, one or more point-to-point connections, etc., or a combination thereof. The volatile memory 2014 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 2016 may be implemented by flash memory and/or any other desired type of memory device. Access to the main memory 2014, 2016 is controlled by a memory controller.

The processor platform 2000 of the illustrated example also includes an interface circuit 2020. The interface circuit 2020 may be implemented by any type of interface standard, such as an Ethernet interface, a universal serial bus (USB), a Bluetooth® interface, a near field communication (NFC) interface, and/or a PCI express interface. In this example, the interface circuit 2020 implements the network interface 305.

In the illustrated example, one or more input devices 2022 are connected to the interface circuit 2020. The input device(s) 2022 permit(s) a user to enter data and/or commands into the processor 2012. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 2000, can allow the user to control the computer system and provide data to the computer using physical gestures, such as, but not limited to, hand or body movements, facial expressions, and face recognition.

One or more output devices 2024 are also connected to the interface circuit 2020 of the illustrated example. The output devices 2024 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speakers(s). The interface circuit 2020 of the illustrated example, thus, typically includes a graphics driver card, a graphics driver chip and/or a graphics driver processor.

The interface circuit 2020 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 2026. The communication can be via, for example, an Ethernet connection, a digital subscriber line (DSL) connection, a telephone line connection, a coaxial cable system, a satellite system, a line-of-site wireless system, a cellular telephone system, etc.

The processor platform 2000 of the illustrated example also includes one or more mass storage devices 2028 for storing software and/or data. Examples of such mass storage devices 2028 include floppy disk drives, hard drive disks, compact disk drives, Blu-ray disk drives, redundant array of independent disks (RAID) systems, and digital versatile disk (DVD) drives. In some examples, the mass storage device(s) 2028 may implement the panelist database 315, the RPD database 325 and/or the constraint database 345. Additionally or alternatively, in some examples the volatile memory 2014 may implement the panelist database 315, the RPD database 325 and/or the constraint database 345.

The machine executable instructions 2032 corresponding to the instructions of FIG. 12 may be stored in the mass storage device 2028, in the volatile memory 2014, in the non-volatile memory 2016, in the local memory 2013 and/or on a removable non-transitory computer readable storage medium, such as a CD or DVD 2036.

FIG. 21 is a block diagram of an example processor platform 2000 structured to execute the instructions of FIGS. 13, 14, 15, 16, 17, 18, and 19 to implement the example neural-network-based demographic estimation system 1000 of FIG. 10. The processor platform 2100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 2100 of the illustrated example includes a processor 2112. The processor 2112 of the illustrated example is hardware. For example, the processor 2112 can be implemented by one or more integrated circuits, logic circuits, microprocessors, GPUs, DSPs, or controllers from any desired family or manufacturer. The hardware processor 2112 may be a semiconductor based (e.g., silicon based) device. In this example, the processor 2112 implements the example panel tuning data collector 310, the example RPD data collector 320, the example feature generator 330, the example household demographic assignment engine 340, the example demographic targets adjuster 1050, the example visitor assignment engine 1055 and the example ratings calculator 350.

The processor 2112 of the illustrated example includes a local memory 2113 (e.g., a cache). The processor 2113 of the illustrated example is in communication with a main memory including a volatile memory 2113 and a non-volatile memory 2116 via a link 2118. The link 2118 may be implemented by a bus, one or more point-to-point connections, etc., or a combination thereof. The volatile memory 2114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 2116 may be implemented by flash memory and/or any other desired type of memory device. Access to the main memory 2114, 2116 is controlled by a memory controller.

The processor platform 2100 of the illustrated example also includes an interface circuit 2120. The interface circuit 2120 may be implemented by any type of interface standard, such as an Ethernet interface, a universal serial bus (USB), a Bluetooth® interface, a near field communication (NFC) interface, and/or a PCI express interface. In this example, the interface circuit 2020 implements the network interface 305.

In the illustrated example, one or more input devices 2120 are connected to the interface circuit 2120. The input device(s) 2122 permit(s) a user to enter data and/or commands into the processor 2112. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 2100, can allow the user to control the computer system and provide data to the computer using physical gestures, such as, but not limited to, hand or body movements, facial expressions, and face recognition.

One or more output devices 2124 are also connected to the interface circuit 2120 of the illustrated example. The output devices 2124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speakers(s). The interface circuit 2120 of the illustrated example, thus, typically includes a graphics driver card, a graphics driver chip and/or a graphics driver processor.

The interface circuit 2120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 2126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 2100 of the illustrated example also includes one or more mass storage devices 2128 for storing software and/or data. Examples of such mass storage devices 2128 include floppy disk drives, hard drive disks, compact disk drives, Blu-ray disk drives, redundant array of independent disks (RAID) systems, and digital versatile disk (DVD) drives. In some examples, the mass storage device(s) 2028 may implement the panelist database 315, the RPD database 325 and/or the constraint database 345. Additionally or alternatively, in some examples the volatile memory 2014 may implement the panelist database 315, the RPD database 325 and/or the constraint database 345.

The machine executable instructions 2132 corresponding to the instructions of FIGS. 13, 14, 15, 16, 17, 18, and 19 may be stored in the mass storage device 2128, in the volatile memory 2114, in the non-volatile memory 2116, in the local memory 2113 and/or on a removable non-transitory computer readable storage medium, such as a CD or DVD 2136.

From the foregoing, it will be appreciated that example methods, apparatus and articles of manufacture have been disclosed that implement neural network processing of set-top box return path data to estimate household demographics. An example neural-network-based demographic estimation system 1000 disclosed above uses a neural network having a time distributed dense layer (TDDL) followed by a long short term memory (LSTM) recurrent network layer to predict demographic classifications of a households (e.g., panel household for training, and RPD households after training) from viewing data (e.g., panelist tuning data for training, and RPD tuning data after training). The example neural-network-based demographic estimation system 1000 groups viewing data for a household into view blocks which describe respective viewing sessions, where a view block indicates the day of the week, the day of the year, the quarter hour of the day, the channel change rate, and the minutes each possible network was viewed. In some examples, viewing blocks are capped at 60 minutes. In some examples, view blocks for a given household are combined and processed by the TDDL to produce a condensed feature set for the viewing sessions of the household. The condensed feature set is then processed by the LSTM to produce a condensed summary feature vector that summarizes the viewing history for the household. The condensed summary feature vector is merged with additional household features, such as total TV consumption, number of view blocks recorded and number of TV tuners in the household, to produce a merged summary feature vector for the household. The merged summary feature vector is then applied to one or more additional hidden layers, which output a classification vector indicating the probability that the household belongs in the different possible demographic classes. Mixed integer programming is then used to solve an objective function based on the demographic classification probabilities output from the neural network, and subject to a set of constraints, to assign one or more demographic categories to respective ones of the RPD households providing the RPD tuning data.

The disclosed methods, apparatus and articles of manufacture improve the efficiency of using a computing device by enabling RPD tuning data to be combined with panelist tuning data in an audience measurement processing system. Combining RPD tuning data with available panel data can greatly increase the amount of data accessible by the audience measurement processing system for predicting audience metrics (e.g., ratings). Such an increased amount of data can improve the statistical completeness of the input data and thereby decrease the associated statistical bias of the results produced by the audience measurement processing system. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A demographic estimation system comprising:
a feature generator to generate features from return path data (RPD) reported from set-top boxes associated with return path data households;
a neural network to process the features generated from the return path data to predict demographic classification probabilities for the return path data households, the neural network to be trained based on panel data reported from meters that monitor media devices associated with panelist households;
a demographic assignment engine to assign one or more demographic categories to respective ones of the return path data households based on the predicted demographic classification probabilities; and
a visitor assignment engine to assign virtual visitors to at least a subset of the respective ones of the return path data households based on the one or more demographic categories assigned to the respective ones of the return path data households.

2. The demographic estimation system of claim 1, further including a demographic targets adjuster to update demographic targets to account for presence of visitors.

3. The demographic estimation system of claim 2, wherein the demographic targets adjuster is to apply scale factors to corresponding ones of demographic targets to update demographic targets to account for presence of visitors.

4. The demographic estimation system of claim 1, wherein the visitor assignment engine includes:
a visitor vector generator to generate a visitor vector containing a first number of visitors; and
a visitor vector assigner to assign the visitor vector to a first one of the return path data households based on respective probabilities that corresponding ones of the return path data households include at least one visitor, the probabilities based on the panel data.

5. The demographic estimation system of claim 4, wherein the visitor vector generator is to select the first number of visitors based on a probability that a percentage of the return path data households have the first number of visitors, the probability that the percentage of the return path data households have the first number of visitors based on panel data.

6. The demographic estimation system of claim 1, wherein the visitor assignment engine includes a visitor demographic distribution calculator to determine, based on the panel data, respective percentages of visitors in ones of the one or more demographic categories.

7. The demographic estimation system of claim 1, wherein the visitor assignment engine includes a visitor household distribution calculator to determine respective percentages of the return path data households having corresponding numbers of visitors.

8. A method to estimate demographics of households with visitors, the method comprising:
generating, by executing an instruction with a processor, features from return path data (RPD) reported from set-top boxes associated with return path data households;
processing, by executing an instruction with the processor, the features generated from the return path data with a neural network to predict demographic classification probabilities for the return path data households, the neural network to be trained based on panel data reported from meters that monitor media devices associated with panelist households;
assigning, by executing an instruction with the processor, one or more demographic categories to respective ones of the return path data households based on the predicted demographic classification probabilities; and
assigning, by executing an instruction with the processor, virtual visitors to at least a subset of the respective ones of the return path data households based on the one or more demographic categories assigned to the respective ones of the return path data households.

9. The method of claim 8, further including updating demographic targets to account for presence of visitors.

10. The method of claim 9, wherein the updating of the demographic targets to account for the presence of visitors includes applying scale factors to corresponding ones of demographic targets.

11. The method of claim 8, wherein the assigning of the virtual visitors to at least a subset of the respective ones of the return path data households includes:
generating a visitor vector containing a first number of visitors; and
assigning the visitor vector to a first one of the return path data households based on respective probabilities that corresponding ones of the return path data households include at least one visitor, the probabilities based on the panel data.

12. The method of claim 11, further including selecting the first number of visitors based on a probability that a percentage of the return path data households have the first number of visitors, the probability that the percentage of the return path data households have the first number of visitors based on panel data.

13. (canceled)

14. The method of claim 8, wherein the assigning of the virtual visitors to at least a subset of the respective ones of the return path data households includes determining respective percentages of the return path data households having corresponding numbers of visitors.

15. At least one non-transitory computer readable medium comprising instructions that, when executed, cause at least one processor to at least:
generate features from return path data (RPD) reported from set-top boxes associated with return path data households;
process the features generated from the return path data with a neural network to predict demographic classification probabilities for the return path data households, the neural network to be trained based on panel data reported from meters that monitor media devices associated with panelist households;
assign one or more demographic categories to respective ones of the return path data households based on the predicted demographic classification probabilities; and
assign virtual visitors to at least a subset of the respective ones of the return path data households based on the one or more demographic categories assigned to the respective ones of the return path data households.

16. The at least one non-transitory computer readable medium of claim 15, wherein the instructions, when executed, cause the at least one processor to update demographic targets to account for presence of visitors.

17. The at least one non-transitory computer readable medium of claim 16, wherein the instructions, when executed, cause the at least one processor to apply scale factors to corresponding ones of demographic targets to update demographic targets to account for presence of visitors.

18. The at least one non-transitory computer readable medium of claim 15, wherein the instructions, when executed, cause the at least one processor to:
generate a visitor vector containing a first number of visitors; and
assign the visitor vector to a first one of the return path data households based on respective probabilities that corresponding ones of the return path data households include at least one visitor, the probabilities based on the panel data.

19. The at least one non-transitory computer readable medium of claim 18, wherein the instructions, when executed, cause the at least one process to select the first number of visitors based on a probability that a percentage of the return path data households have the first number of visitors, the probability that the percentage of the return path data households have the first number of visitors based on panel data.

20. The at least one non-transitory computer readable medium of claim 15, wherein the instruction, when executed, cause the at least one processor to determine, based on the panel data, respective percentages of visitors in ones of the one or more demographic categories.

21. The at least one non-transitory computer readable medium of claim 15, wherein the instruction, when executed, cause the at least one processor to determine respective percentages of the return path data households having corresponding numbers of visitors.

22-28. (canceled)
